(19) United States
(12) Patent Application Publication
(10) Pub. No.: US 2026/0340118 A1
(43) Pub. Date: Oct. 29, 2026

(54) APPARATUS FOR PROCESSING CYBER THREAT INFORMATION, METHOD FOR PROCESSING CYBER THREAT INFORMATION, AND NON-TRANSITORY STORAGE MEDIUM FOR STORING A COMPUTER-READABLE PROGRAM PROCESSING CYBER THREAT INFORMATION

(71) Applicant: SANDS LAB INC., Gwacheon-si (KR)

(72) Inventors: Ki Hong KIM, Seoul (KR); Suh Mahn HUR, Gwacheon-si (KR); Min Jun CHOI, Seoul (KR); Chan Been JEON, Osan-si (KR); Chang Gyun KIM, Paju-si (KR); Sueng Bum LIM, Seoul (KR)

(21) Appl. No.: 19/424,415

(22) Filed: Dec. 18, 2025

(30) Foreign Application Priority Data
Apr. 24, 2025 (KR) 10-2025-0054080

(51) Int. Cl. G06F 21/55

(52) U.S. Cl. CPC G06F 21/554; G06F 2221/034

(57) ABSTRACT

Disclosed herein are an apparatus and a method for processing cyber threat information. The apparatus for processing cyber threat information includes a database configured to store data and a processor configured to process the data. The processor is further configured to convert a target function included in a file to a first hash value, search for a comparison function having a similar hash value with the first hash value of the target function based on one or more similarity analyses, generate one or more prompts using one or more Artificial Intelligence (AI) agents, the prompts including a query regarding similarity between the first hash value and a hash value of the retrieved comparison function, submit the one or more prompts to one or more natural language models and obtaining a natural language report of cyber threat information of the target function.

### CROSS-REFERENCE TO RELATED APPLICATIONS

This application claims the benefit of Korean Patent Application No. 10-2025-0054080, filed Apr. 24, 2025, which are/is hereby incorporated by reference in its entireties into this application.

### BACKGROUND

### 1. Field

The following disclosure relates to an apparatus for processing cyber threat information, a method for processing cyber threat information, and a non-transitory storage medium for storing a computer-readable program processing cyber threat information.

### 2. Discussion of the Related Art

The damage caused by cyber security threats, which are gradually becoming more sophisticated centering on malicious codes such as new types or variants, is increasing.

In order to reduce such damage even slightly and to respond at an early stage, the advancement of response technologies is being carried out in parallel through multi-dimensional pattern configuration and various complex analyses.

Until now, for enterprise security, enterprises have focused on boundary-based security that detects and blocks traffic between the inside and outside of the enterprise through technologies such as a Virtual Private Network (VPN), a firewall, and an Intrusion Detection System (IDS)/Intrusion Prevention System (IPS).

However, due to the complexity of technology, the diversity of attacks, and the increase in attack target contact points, they are experiencing difficulties in security measures. In order to respond to cyber threats through network-based traffic, traffic analysis based on a network layer or a transport layer has a problem in that threat information cannot be analyzed comprehensively and visibly.

Therefore, the detection of cyber threats through network-based traffic targets only Information Technology (IT) assets, and there was a problem in that threats to Operation Technology (OT) assets or Internet of Things (IoT) devices could not be detected or identified.

Regarding cyber threats through network-based traffic, the analysis is fragmentary, and in most cases, only analysis after an infringement incident is possible, and there was a problem in that it is difficult to analyze a large amount of network traffic in real time and respond to cyber threats.

In addition, malicious acts according to cyber threat information are analyzed as information that cannot be accurately described without various ununified techniques or experts, so the mechanism and basis of analysis could not be easily understood.

Meanwhile, in order to respond to cyber threat acts, the above analysis requires a high-quality artificial intelligence training data set, but such data were difficult to find.

Even companies trying to develop technologies capable of responding to cyber threats using artificial intelligence have a problem in that it is difficult to find appropriate data or malicious code samples.

Under this background, the demand for high-quality datasets for artificial intelligence training has recently surged, but there have been technical difficulties and challenges in securing the desired malware analysis data.

### SUMMARY

An object of the disclosure below is to solve the above problems and to provide an apparatus for processing cyber threat information, a method for processing cyber threat information, and a storage medium for storing a program processing cyber threat information, which can comprehensively and visibly analyze cyber threat information through network-based traffic.

Another object of the disclosure is to provide an apparatus for processing cyber threat information, a method for processing cyber threat information, and a storage medium for storing a program processing cyber threat information, which can detect or identify cyber threats of various assets such as Operation Technology (OT) assets or IoT devices as well as IT assets.

Still another object of the disclosure is to provide an apparatus for processing cyber threat information, a method for processing cyber threat information, and a storage medium for storing a program processing cyber threat information, which can analyze network traffic in real time and respond to cyber threats.

Another object of the disclosure is to provide an apparatus for processing cyber threat information, a method for processing cyber threat information, and a storage medium for storing a program processing cyber threat information, wherein, regarding detected or analyzed cyber threat information, even if a user is not an expert, the user can easily understand the mechanism and basis of analysis thereof.

Another object of the disclosure t provides an apparatus for processing cyber threat information, a method for processing cyber threat information, and a program processing cyber threat information, which can easily obtain malicious code analysis data so as to respond to cyber threats, and can acquire a data set that is specifically required or technically necessary.

Another object of the disclosure is to provide an example of cyber threat information processing capable of efficiently analyzing cyber threat information by converting it into a function-based code set with high readability.

Another object of the disclosure is to provide an example of cyber threat information processing capable of improving analysis results with an automated and reliable process.

Another object of the disclosure is to provide an example of cyber threat information processing capable of automating code analysis, detecting malicious code to analyze vulnerabilities, and tracking code changes.

Another object of the disclosure is to provide an example of cyber threat information processing capable of efficiently performing similarity analysis of functions and automatically generating a cyber threat information report including reliable results, even when it is difficult to identify a variant conventionally.

However, the problems that the embodiments seek to solve are not limited to the problems described above and may be variously expanded within the scope of the technical ideas included in the embodiments.

In accordance with an aspect of the present disclosure, disclosed herein is an embodiment of a method of processing cyber threat information. The embodiment converts a target function included in a file to a first hash value, searches for a comparison function having a similar hash value with the first hash value of the target function based on one or more similarity analyses, generates one or more prompts using one or more Artificial Intelligence (AI) agents. Herein the prompts includes a query regarding similarity between the first hash value and a hash value of the retrieved comparison function. The embodiment further submits the one or more prompts to one or more natural language models and obtains a natural language report of cyber threat information of the target function.

Here, a first AI agent among the one or more AI agents generates a query prompt requesting analysis of code differences between the target function and the comparison function. A second AI agent among the one or more AI agents generates a query prompt requesting analysis of a change or difference in functionality between the target function and the comparison function, and a third AI agent among the one or more AI agents generates a query prompt requesting analysis of an impact of the target function and the comparison function on cyber threats. And, a fourth AI agent among the one or more AI agents generates a query prompt requesting a summary regarding cyber threats of the target function and the comparison function.

As another aspect of the present disclosure, provided is an apparatus for processing cyber threat information. The apparatus includes a database configured to store data, and a processor configured to process the data. And the processor is further configured to convert a target function included in a file to a first hash value, search for a comparison function having a similar hash value with the first hash value of the target function based on one or more similarity analyses, generate one or more prompts using one or more Artificial Intelligence (AI) agents, the prompts including a query regarding similarity between the first hash value and a hash value of the retrieved comparison function, submit the one or more prompts to one or more natural language models and obtaining a natural language report of cyber threat information of the target function.

As another aspect of the present disclosure, provided is a non-transitory storage medium storing a computer-readable program, the program. The program may perform operations including converting a target function included in a file to a first hash value, searching for a comparison function having a similar hash value with the first hash value of the target function based on one or more similarity analyses, generating one or more prompts using one or more Artificial Intelligence (AI) agents, the prompts including a query regarding similarity between the first hash value and a hash value of the retrieved comparison function, and submitting the one or more prompts to one or more natural language models and obtaining a natural language report of cyber threat information of the target function.

According to the disclosed embodiments, it is possible to comprehensively and visibly analyze cyber threat information through network-based traffic.

According to the disclosed embodiments, it is possible to detect or identify cyber threats of various assets such as Operation Technology (OT) assets or IoT devices as well as IT assets.

According to the disclosed embodiments, it is possible to analyze network traffic in real time and respond to cyber threats.

According to the disclosed embodiments, regarding detected or analyzed cyber threat information, even if a user is not an expert, the user can easily understand the mechanism and basis of analysis thereof.

According to the disclosed embodiments, it is possible to identify vulnerabilities of an asset through ASM (Attack Surface Management) performance, thereby applying security control and performing reinforcement of cyber security strategies and policies for the asset.

According to the disclosed examples, it is possible to easily obtain malicious code analysis data so as to respond to cyber threats, and to acquire a data set that is specifically required or technically necessary.

According to the embodiments, even if malicious code is obfuscated in an execution file or it is difficult to grasp the execution flow of an internal function, it is possible to efficiently analyze cyber threat information by converting it into a function-based code set with high readability.

According to the embodiments, even when the execution flow of functions included in a file is complex, or it is difficult to identify how much the function contributes to malicious code, or the judgment criteria for the contribution to a malicious act depend on the capability of an expert, it is possible to improve analysis results with an automated and reliable process.

According to the embodiments, it is possible to automate code analysis, detect malicious code to analyze vulnerabilities, and track code changes.

According to the embodiments, even when it is difficult to identify a variant conventionally, it is possible to efficiently perform similarity analysis of functions and automatically generate a cyber threat information report including reliable results.

According to the embodiments, it is possible to reduce time and effort for manually analyzing and generating cyber threat information, and to automatically generate reports on the analysis of a plurality of files.

However, the effects of the embodiments are not limited to the effects described above, and it is apparent that they can be variously expanded without departing from the spirit and scope of the embodiments.

### BRIEF DESCRIPTION OF THE DRAWINGS

FIG. 1 illustrates an embodiment of a method for processing cyber threat information according to an embodiment.

FIG. 2 illustrates another embodiment of a method for processing cyber threat information according to an embodiment.

FIG. 3 illustrates embodiments of an apparatus for processing cyber threat information according to an embodiment.

FIG. 4 illustrates a first CTI device as an embodiment of an apparatus for processing cyber threat information according to an embodiment.

FIG. 5 discloses an example in which a first CTI device and a second CTI device interwork as an embodiment of apparatuses for processing cyber threat information.

FIG. 6 discloses another example in which a first CTI device and a second CTI device interwork as an embodiment of apparatuses for processing cyber threat information according to an embodiment.

FIG. 7 discloses embodiments of an apparatus for processing cyber threat information.

FIG. 8 discloses an embodiment of active ASM performance based on network traffic collection.

FIG. 9 discloses an embodiment of provision of identified vulnerability contents and measures by ASM technology.

FIG. 10 discloses an embodiment of a method for processing cyber threat information.

FIG. 11 discloses another embodiment of an apparatus for processing cyber threat information.

FIG. 12 discloses an embodiment of a method for processing cyber threat information.

FIG. 13 discloses a quantization technique used by a method for processing cyber threat information according to an embodiment.

FIG. 14 discloses a quantization technique used by a method for processing cyber threat information according to an embodiment.

FIG. 15 discloses an embodiment of a method for processing cyber threat information according to an embodiment.

FIG. 16 discloses another example of an apparatus for processing cyber threat information generating data for artificial intelligence training capable of responding to cyber threats.

FIG. 17 discloses an example of providing a malicious code dataset according to an embodiment.

FIG. 18 discloses an example of processing cyber threat information capable of providing a dataset.

FIG. 19 discloses another embodiment providing disclosed cyber threat information.

FIG. 20 discloses an example of obtaining a code set for a readable function from an execution file among the embodiments described above.

FIG. 21 discloses another example of an apparatus processing cyber threat information.

FIG. 22 illustrates code converted into assembly language by disassembling a file and decompiled code.

FIG. 23 discloses an example of processing cyber threat information corresponding to a function unit as another embodiment of processing cyber threat information.

FIG. 24 discloses another embodiment of processing cyber threat information.

FIG. 25 discloses an example of pre-processing a function unit code set as an embodiment of processing cyber threat information.

FIG. 26 discloses an example of generating a query for a function unit code set as an embodiment of processing cyber threat information.

FIG. 27 discloses an example of obtaining a query result for a function unit code set as an embodiment of processing cyber threat information.

FIG. 28 discloses an example of processing a natural language processing result as an embodiment of processing cyber threat information.

FIG. 29 discloses another embodiment of a method for processing cyber threat information.

FIG. 30 discloses another embodiment of a cyber threat device processing cyber threat information.

FIG. 31 discloses an embodiment of a method for processing cyber threat information.

FIG. 32 discloses an example of a cyber threat device implementing an embodiment of the disclosed cyber threat processing.

FIG. 33 discloses another embodiment of a method for processing cyber threat information.

FIG. 34 discloses another embodiment of an apparatus processing cyber threat information.

### DETAILED DESCRIPTION

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide a thorough understanding of the present invention. However, it will be apparent to those skilled in the art that the present invention may be practiced without such specific details.

Hereinafter, embodiments will be illustrated and described in detail with reference to the accompanying drawings.

In the embodiments, an engine, various analysis tools, a module, and the like may be implemented as a physical device, a device combined with the physical device, or software.

When an embodiment is implemented as software, it may be stored on a computer-readable non-volatile storage medium, installed on a computer or the like, and executed by a processor.

Detailed embodiments of the cyber threat information processing apparatus and the cyber threat information processing method are as follows.

In wired and wireless network communication between two or more devices, various types of cyber threat information at different network levels may induce complex abnormal behaviors in the devices simultaneously or with a time difference. These complex cyber threats and abnormal behaviors are hereinafter referred to as a cyber threat campaign.

The disclosed embodiments may include two or more different types of cyber threat information processing apparatuses. Therefore, for convenience, in the embodiments, one or more cyber threat information processing apparatuses are referred to as the N-th cyber threat information (CTI) device (N is a natural number).

The disclosed embodiments can detect and analyze cyber threat information included in network communication and, based on this, further analyze the cyber threat information in detail through cooperation between devices, or allow the analyzed results to be explained to the user very easily, or to enable response or prediction.

The CTI device of the following embodiments may be implemented as a physical device connected to a wired or wireless communication network, and may be implemented according to the same features and principles in a device connected to a network such as an artificial satellite or a spacecraft. Furthermore, the CTI device may be a device that has a small storage device and is directly connected to the network, such as a network black box or a camera device.

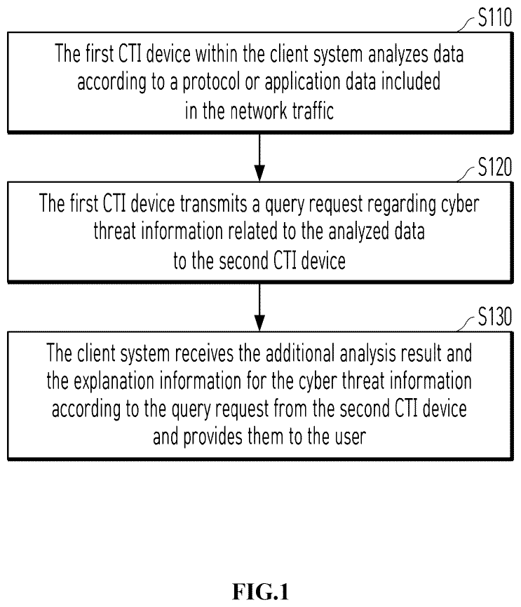

FIG. 1 illustrates an embodiment of a cyber threat information processing method according to an embodiment.

One or more embodiments of the disclosed cyber threat information processing method can collect, analyze, and detect data based on communication network traffic, manage cyber threat information from the results, and respond to cyber threats.

In the embodiments, it is assumed that a first CTI device is a device included in a client system to detect and analyze cyber threat information on network communication, and a second CTI device exemplifies a device that provides a platform-based service based on a computing server and a database in which cyber threat information is analyzed.

The first CTI device within the client system analyzes data according to a protocol or application data included in the network traffic (S110).

The first CTI device can collect network traffic, classify layer-specific data according to the OSI layers, and analyze whether cyber threat information exists according to a protocol or an application.

The first CTI device transmits a query request regarding cyber threat information related to the analyzed data to the second CTI device (S120).

The first CTI device can obtain additional detailed cyber threat information by requesting a query to the second CTI device regarding the cyber threat information primarily analyzed as above.

The second CTI device can additionally analyze the cyber threat information according to the query request analyzed by the first CTI device or generate explanation information based on artificial intelligence natural language processing for the analyzed cyber threat information.

The client system receives the additional analysis result and the explanation information for the cyber threat information according to the query request from the second CTI device and provides them to the user (S130).

The client system can obtain the analysis result and the explanation information for the cyber threat information analyzed by the first CTI device or additionally analyzed by the second CTI device.

The client system can provide the received additional analysis result and the explanation information for the cyber threat information to the user. When providing to the user, the client system can provide the user with cyber threat information related to abnormal behavior, malicious behavior, attack behavior, and the like, through a monitoring module or the like of the client system.

The client system can obtain a detailed analysis result and natural language-based explanation information from the second CTI device as to what information the corresponding cyber threat information is.

Accordingly, the user can perform a response or preventive measure for the analyzed cyber threat information.

One or more embodiments for the first CTI device and the second CTI device that collect network traffic and analyze cyber threat information will be described in detail below.

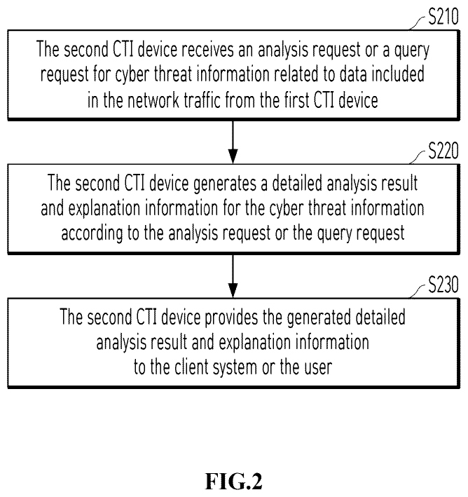

FIG. 2 illustrates a view illustrating another embodiment of a method for processing cyber threat information according to an embodiment.

The second CTI device receives an analysis request or a query request for cyber threat information related to data included in the network traffic from the first CTI device (S210).

Here, the second CTI device may be a natural language model that explains a query regarding CTI intelligence in natural language and provides the basis for the explanation, or may include the natural language model. Detailed examples of the natural language model are disclosed below.

If the second CTI device is a data platform including the natural language model exemplified below, the second CTI device can receive an analysis request or a query request for cyber threat information from the client system or from the first CTI device included in the client system through the Application Programming Interface.

The first CTI device can transmit additional analysis information or a query request for cyber threat information directly analyzed in the network traffic.

The second CTI device can generate a detailed analysis result and explanation information for the cyber threat information according to the analysis request or the query request (S220).

The second CTI device can convert various formats of requested files into binary data, or analyze attack behavior, attackers, and the like for a cyber threat campaign or the like through feature analysis.

The second CTI device can classify cyber threat information such as attack behavior and attackers, or generate a detailed analysis result through an AI (artificial intelligence) engine based on the characteristics of the analyzed data.

The second CTI device can generate natural language explanation information for the query request of the analyzed cyber threat information based on the internal natural language model.

The second CTI device can provide the generated detailed analysis result and explanation information to the client system or the user (S230).

One or more Embodiments for the second CTI device regarding cyber threat information through artificial intelligence processing will be described in detail below.

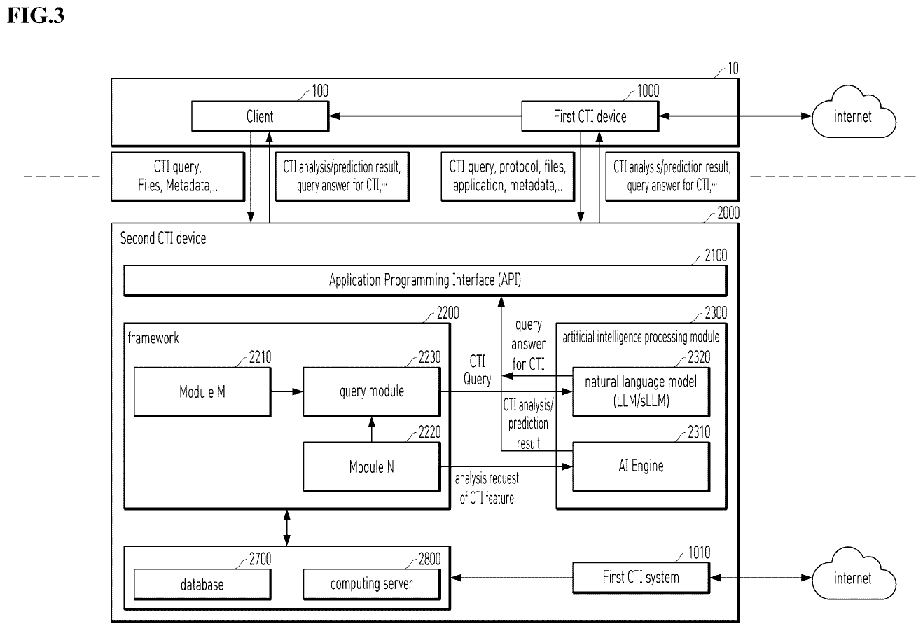

FIG. 3 discloses an example of the cyber threat information processing apparatus according to an embodiment.

This disclosed embodiment may include a client system 10 and a second CTI device 2000.

The client system 10 may include a client device 100 and a first CTI device 1000.

The client system 10 can receive network traffic from the Internet through the first CTI device 1000.

The second CTI device 2000 includes a computing server 2800 and a database 2700, and may include a framework 2200 that provides an Application Programming Interface (API) and an artificial intelligence processing module 2300.

Unless the client system 10 and the second CTI device 2000 are connected by an intranet or the like, the second CTI device 2000 may include a separate first CTI system 1010 and can receive network traffic from the Internet through it.

The first CTI device 1000 within the client system 10 can analyze layer-specific protocol data from the network traffic and application data transmitted through the traffic to obtain metadata related to the protocol, and executable or non-executable files within the payload.

The first CTI device 1000 can analyze the data or file received as above to detect or extract cyber threat information and provide it to a monitoring system (not shown) connected to the client device 100.

Alternatively, the first CTI device 1000 can request the second CTI device 2000 for additional analysis of the cyber threat information analyzed as above, or request a query related to that cyber threat information.

Separately, the client device 100 can request the second CTI device 2000 for additional analysis of the cyber threat information of a file or metadata transmitted from an external network through the first CTI device 1000, or request a query related to that cyber threat information.

The second CTI device 2000 can receive a file, metadata, or its cyber threat information (CTI), or a query the cyber threat information (CTI query, hereinafter CTI query) regarding, transmitted by the client device 100 or the first CTI device 1000 through the Application Programming Interface (API) 2100.

Here, the query regarding cyber threat information may include, for example, malignancy status, a hash value of a file, assembly code or function information included in the assembly code, and other information related to the file.

The received files can be analyzed in several modules within the framework 2200 of the second CTI device 2000. Here, the multiple modules are simplified and expressed as Module M 2210 or Module N 2220.

For example, Module M 2210 or Module N 2220 of the framework 2200 can perform malicious behavior analysis on layer-specific metadata of a network, executable files, non-executable files, or web data collected from the Internet, and the like.

Meanwhile, the query module 2230 of the framework 2200 transmits a CTI query related to a file and metadata delivered by the client system 10 to the natural language model 2320 of the artificial intelligence processing module 2300, and an CTI feature analysis request to the AI engine 2310 of the artificial intelligence processing module 2300, respectively.

Module M 2210 or Module N 2220 can transmit the analysis information of the file related to the cyber threat information (CTI) or CTI query inquired by the client device 100 to the query module 2230. For example, Module M 2210 or Module N 2220 can transmit information about the malignancy status, attack behavior, attack technique, attack group, or an attack campaign in which various attack behaviors are linked, of the analyzed file or data, to the query module 2230.

The query module 2230 can generate a CTI query for the file, metadata, or the related cyber threat information (CTI) submitted by the client device 100 or the first CTI device 1000.

The query module 2230 can generate an appropriate CTI query related to the network protocol or application data, file, metadata analyzed by Module M 2210 or Module N 2220, and cyber threat information analyzed from the file or data (for example, information about malignancy status, attack behavior, attack technique, attack group, or an attack campaign in which various attack behaviors are linked).

Then, the natural language model 2320 of the artificial intelligence processing module 2300 can generate a natural language answer for the CTI query based on the network protocol/application data, file, and various cyber threat information (CTI) analyzed by Module M 2210 or Module N 2220, and the like.

The first CTI device 1000 transmits the protocol data or application data, the file in the payload, the metadata, and the related CTI query in the network traffic to the second CTI device 2000.

The client device 100 transmits the file delivered from the first CTI device 1000 and the CTI query related to the file and the like to the second CTI device 2000.

The framework 2200 of the second CTI device 2000 can perform cyber threat information (CTI) analysis on protocol data or application data, files, metadata, and the like, and extract CTI features.

The CTI features analyzed and extracted in the framework 2200 generate a more accurate CTI analysis result or CTI prediction result in the AI engine 2310 of the artificial intelligence processing module 2300. The generated CTI analysis result or CTI prediction result is transmitted to the client system 10 through the Application Programming Interface (API) 2100.

The CTI query related to the CTI features output from the framework 2200 is generated as a natural language analysis result in the natural language model 2320 of the artificial intelligence processing module 2300. The natural language query answer for the generated CTI query is transmitted to the client system 10 through the Application Programming Interface (API) 2100.

The natural language CTI query answer generated by the natural language model 2320 is provided to the client system 10 along with the CTI analysis result generated in this way.

The CTI query answer includes a natural language explanation for the cyber threat information (CTI) inquired about by the client system 10, particularly the first CTI device 1000, in relation to the data analyzed and extracted from the network traffic, such as malignancy status, attack behavior, attack technique, attack group, or an attack campaign in which various attack behaviors are linked.

In addition, for queries regarding binary data such as assembly code of a file included in the network traffic and functions included in the data, explanation information regarding whether it is related to the malignancy status can be provided based on the results analyzed by the second CTI device 2000.

The framework 2200 of the second CTI device 2000 provides various analysis information about a file or information already analyzed and stored in the database 2700, and can generate various CTI additional queries related to the CTI query of the client system 10 or suggest them to the user.

Furthermore, the natural language model 2320 of the second CTI device 2000 generates natural language explanations for the CTI query submitted by the client system 10 and the CTI additional queries provided by the framework 2200, and provides a natural language answer related to the CTI query to the user of the client system 10.

Since the embodiments provide the information analyzed or already analyzed by the second CTI device 2000 along with natural language, according to the embodiments, easy and accurate information delivery and response to cyber threat information are possible even if the user is a non-expert.

If the computing server 2800 providing the second CTI device 2000 is connected to the Internet through a separate first CTI system 1010, the function of the first CTI system 1010 is the same as the function of the disclosed first CTI device 1000.

Embodiments of the first CTI device 1000 or the first CTI system 1010 and the second CTI device 2000 including the natural language model 2320 will be described in detail below.

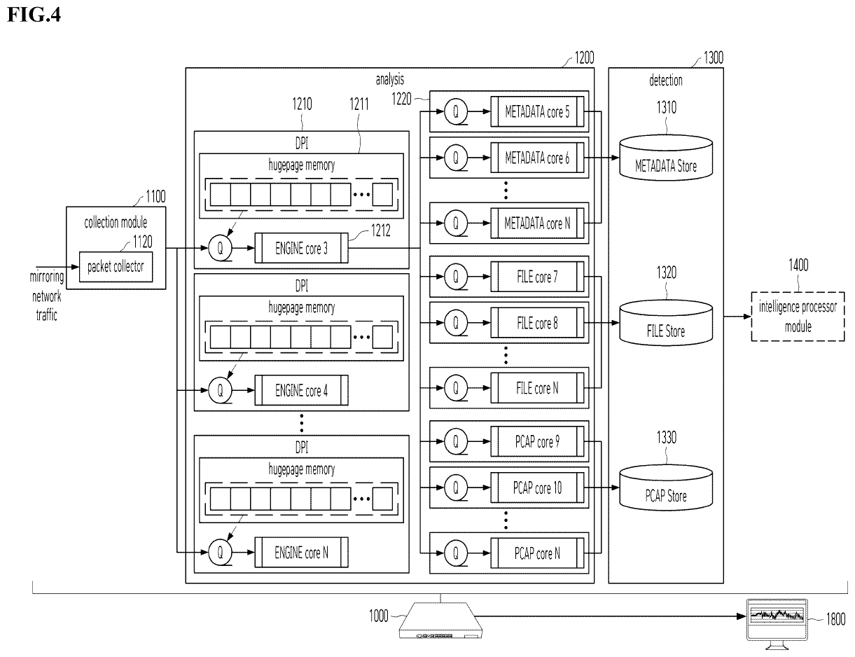

FIG. 4 illustrates a first CTI device 1000 as an embodiment of the cyber threat information processing apparatus according to an embodiment.

The disclosed embodiment of the first CTI device 1000 includes a collection module 1100 that collects transmission data from mirrored network traffic, an analysis module 1200 that analyzes data according to a protocol or an application within the collected data, and a detection module 1300 that detects cyber threat information from the analyzed data.

The data analyzed by the first CTI device 1000 is provided to the user of the client system 10 through the monitoring module 1800, and the user can monitor abnormal behavior or threatening behavior on the network.

The collection module 1100 includes a packet collector 1120, and the packet collector 1120 can collect various metadata for enhanced security from the packet data collected without loss.

As the packet collector 1120 of the collection module 1100 collects various metadata from the packets, the analysis module 1200 can efficiently process multiple packets and pre-allocate the packets to memory to prevent unnecessary latency.

Generally, the packet processing speed of an operating system often cannot keep up with the processing speed of a network interface card (NIC). A disclosed embodiment can allow packet processing performed in the kernel of the operating system to be processed in a user space using a high-speed processing library.

A disclosed embodiment of the collection module 1100 enables a process of the operating system to read data at high speed by polling packets received at the network interface card without using the kernel, using a high-speed processing library. Therefore, the embodiment of the collection module 1100 can reduce idle time that occurs in the process where the operating system's kernel reads packets received by the network interface card and transmits them to the operating system's process.

In the disclosed embodiment, the collection module 1100 may include a network interface card (not shown) and the packet collector 1120.

The network interface card (not shown) can receive network packets at high speed.

The packet collector 1120 of the collection module 1100 reads received packets and transmits them to the processor in a polling manner without going through the kernel.

A receiving core within the packet collector 1120 of the collection module 1100 can store packets received at high speed in a polling manner into a large-capacity memory. The receiving core of the collection module 1100 is used to perform isolated tasks using a dedicated core of the processor so as to protect against malicious software and the like included in the high-speed received packets from affecting related processes.

The receiving core of the collection module 1100 can protect the computer operating system and enhance security features even when receiving packets at high speed. The memory within the collection module 1100 may use a large-capacity memory that can reduce management overhead such as memory faults according to its management function.

The memory of the collection module 1100 may or may not be configured as a large-capacity memory according to the operating system's settings.

A copy core of the collection module 1100 can copy and output the packets stored in the memory.

The analysis module 1200 can inspect, manage, and filter the packets collected by the collection module 1100 using a DPI (Deep Packet Inspection) method. The DPI method can inspect the contents of the data within the collected packets in detail, up to the OSI Layer 7 level. Through this, the DPI method can not only grasp the overall characteristics of the network data but also control potential and malicious traffic.

The DPI engine 1210 that performs the DPI method monitors and reassembles the collected packets between a source and a destination, and inputs them into a separate buffer. And the DPI engine 1210 can form a single session from the input packets and generate metadata based on it.

The packets analyzed by the DPI engine 1210 of the analysis module 1200 are stored in the queue storage 1220 according to their content and then output.

The queue storage 1220 of the analysis module 1200 can synchronize memory access by completing a call within a set time unit when data is called simultaneously by multiple threads.

The analysis module 1200 can resolve issues related to system synchronization using a multi-threaded environment when the analyzed data is diverse, such as metadata, files, or PCAP packet files, by using multiple queue storage 1220 units.

The DPI engine 1210 of the analysis module 1200 pre-allocates the internal memory 1211 of the analysis module 1200 to store data and stores the data output by the collection module 1100.

The DPI engine 1210 of the analysis module 1200 can analyze the syntax in detail and extract files in real time for the data stored in the internal memory 1211.

The DPI engine 1210 of the analysis module 1200 can extract metadata of data across all layers, from layers L2 to L4 as well as the application layer (layer 7). The data extracted by the DPI engine 1210 of the analysis module 1200 is as follows.

For example, the DPI engine 1210 of the analysis module 1200 can obtain application layer information within the payload of a packet, rather than simply obtaining transport layer information such as the Internet Protocol of Source IP, Destination IP, or TCP/UDP from the packet header.

The DPI engine 1210 of the analysis module 1200 can extract metadata of application protocols necessary for network threat detection, such as HTTP, SSL, SSH, FTP, SMB, and DNS, and metadata related to contents such as webpages, filenames, User Agent String, Java Script, and images.

And the DPI engine 1210 of the analysis module 1200 can also extract metadata for OT protocols such as industrial application protocols or engineering protocols.

For example, it can also generate metadata for MODBUS, a network communication encapsulated in the payload of TCP, DNP3, widely used in the energy sector, and BACnet and KNX protocols mainly used in smart buildings.

The core engine 1212 within the analysis module 1200 can separate data transmitted according to the layer or industry-specific protocol in a packet by type and transmit it to the queue storage 1220 according to the data type. The queue storage 1220 within the analysis module 1200 is arranged in parallel according to the data, configured to allow for horizontal scalability depending on the data type and scale.

In this way, the analysis module 1200 can secure visibility for data of all layers according to the packet structure, based on the characteristics of the network protocol.

The analysis module 1200 can extract data and metadata on the protocols of IT networks and OT networks.

The analysis module 1200 can classify data according to the protocol and classify the corresponding metadata and files, and for data of the same source/destination, it can be converted into a single session's PCAP packet file, and then metadata according to the PCAP packet can be generated and stored.

The detection module 1300 can detect threat elements based on the metadata added by the analysis module 1200, the files within the packets, and the reassembled PCAP packet files.

The detection module 1300 can detect the event features such as file types, attack behavior types, and OT types as abnormal behavior through profiling.

For example, the detection module 1300 can detect malware using at least one of an Indicator of Compromise (IoC), rule-based malware detection tools like YARA rules, or machine learning.

The detection module 1300 can detect abnormal behavior through various rules that can find an attacker's tactic, technique, and procedure (TTP) according to the attack's lifecycle, and AI-based behavioral analysis.

The detection module 1300 can perform anomaly detection in an Operational Technology (OT) environment within an enterprise network.

The detection module 1300 can load the extracted event features, apply an AI algorithm to generate a behavioral profile, and calculate a risk score using weights and the like based on the confidence score of the generated behavioral profile model to detect threat elements.

For example, the detection module 1300 can identify threat elements by accumulating scores based on correlation and statistical analysis regarding the respective threat elements of metadata, files, and PCAP packet files, and store them in the respective database 1310, 1320, or 1330 units.

Through this step-by-step and comprehensive method, the detection module 1300 can reduce the false positive rate and enable the user to conduct efficient investigation and response to threat elements.

The detection module 1300 can identify and detect a threat element from the data analyzed by the analysis module 1200, and provide the result to the monitoring module 1800.

When the detection module 1300 identifies a threat element from abnormal events in the metadata extracted or generated as above and the data within the packet's payload, it can perform highly reliable threat element detection by evaluating the threat status, threat level, and context information based on correlation analysis.

The detection module 1300 can perform malware detection, behavioral analysis-based detection, and OT anomaly detection from the input network traffic.

### (a) Malware Detection

The detection module 1300 can detect malware using known malware via an Indicator of Compromise (IoC) from the network traffic.

And the detection module 1300 can detect unknown malware using a machine learning technique.

The detection module 1300 can disassemble or convert a file within the network traffic into binary data and perform machine learning training on malicious files and normal files to identify an attacker and attack behavior for an unknown file. The detection module 1300 can detect malware using a learning model based on the Random Forest algorithm based on the features of the file's binary data.

And it can identify an advanced persistent threat (APT) based on defined rules such as YARA rules.

The detection module 1300 can classify a predefined signature as malware based on defined rule-based strings or a binary pattern (Hex string). The detection module 1300 can identify malware using pattern matching based on regular expressions such as specifying a specific Entry Point value, or a File Offset or a Virtual Memory Address.

### (b) Behavioral Analysis-Based Detection

The detection module 1300 can detect attack TTP based on behavioral analysis for data included in the network traffic.

The detection module 1300 can detect attack behavior based on behavioral analysis through threat detection according to a plurality of behavioral rules. The detection module 1300 applies various AI-based anomaly detection techniques to many features extracted from the network traffic. And the detection module 1300 can evaluate the anomaly status of network traffic by generating hundreds or more Anomaly Models profiled through entity modeling at device/peer group/network levels.

The detection module 1300 can evaluate the anomaly status by comparing the extracted feature with the past pattern of the device (device modeling), evaluating distinctiveness within a cluster (peer group modeling), or investigating scarcity across the entire network, and calculating an anomaly score using the Anomaly Model.

The detection module 1300 can detect threat elements in the Anomaly Model by calculating a threat score for one or more abnormal events through a threat detector.

### (c) Operational Technology (OT) Anomaly Detection

In an OT environment designed to maintain safety, uptime, and productivity, the detection module 1300 exists to manage physical operations in various industries that benefit from operations, particularly automation and mechanization. The detection module 1300 can detect threat elements in an OT environment designed to maintain safety, uptime, and productivity, using whitelist-based anomaly detection technology and ML-based anomaly detection technology for time-series process values for anomaly detection.

The detection module 1300 can detect threat elements based on a whitelist and a sensor's time-series.

When the detection module 1300 analyzes whitelist-based data, it can extract the command field of the protocol included in the data to detect communication in a malformed format or an application misuse threat. Additionally, the detection module 1300 can understand the specialized meaning of each OT protocol to map the detailed message fields of each command and the request and response messages as a pair of sessions, analyze them, and select allowed packets based on statistics.

When the detection module 1300 detects a time-series based threat element of a sensor, it can configure a specific process value extracted from a packet as a time series and compare it with a model trained by machine learning to check for anomalies.

The detection module 1300 allows the administrator to perform a pre-test on a model generated by selectively training a specific process using machine learning to confirm the accuracy performance.

### (d) Correlation Analysis

When the detection module 1300 detects a threat element by performing malware detection, behavioral analysis-based detection, and OT anomaly detection on the packet's metadata and payload data, it can identify whether it is an actual threat technique through correlation analysis on the detected threat element.

The detection module 1300 may include a plurality of threat detectors for correlation analysis. The plurality of threat detectors can perform multiple AI-based anomaly detections and identify a threat technique with a defined rule by performing correlation analysis on various contexts.

Meanwhile, the embodiment of the first CTI device 1000 may further include an intelligence processor module 1400.

The intelligence processor module 1400 can receive an executable file or a non-executable file included in the packet's payload from the analysis module 1200. And the intelligence processor module 1400 can receive the file, metadata, application, and the like analyzed from the network traffic from the detection module 1300.

When the intelligence processor module 1400 intends to detect and identify detailed cyber threat information based on the executable file or the non-executable file, it can transmit the corresponding executable file or non-executable file, or its analyzed metadata, to a cyber threat information system.

One or more embodiments of the intelligence processor module 1400 may include the analysis modules included in the framework 2200 of the embodiment of the second CTI device 2000 disclosed above, and the AI engine 2310 of the artificial intelligence processing module 2300. In this case, the intelligence processor module 1400 can analyze the attack behavior, attacker, and campaign, and the like, included in the metadata, file, and PCAP packets detected by the detection module 1300, and classify them using the AI engine 2310.

The cyber threat information system can identify attack TTP for the received file, and provide profiling results such as the attacker of an Advanced Persistent Threat (APT) and identifiers of attack behavior (including attack behavior identifiers based on the MITRE ATT&CK Matrix).

Alternatively, the embodiment of the first CTI device 1000 may request that the collected and analyzed data be transmitted to the second CTI device 2000 for processing, in relation to the intelligence profiling process as described above.

Another embodiment of the intelligence processor module 1400 may include the analysis modules included in the framework 2200 of the embodiment of the second CTI device 2000 disclosed above, and the AI engine 2310 of the artificial intelligence processing module 2300, and may further include a natural language model 2320.

In this case, the embodiment of the first CTI device 1000 may generate explanation information of the profiled CTI intelligence or a CTI query answer in an internal artificial intelligence-based natural language model 2320 without needing to query the analyzed data related to the intelligence profiling process to the second CTI device 2000.

When the embodiments of the first CTI device 1000 include the natural language model 2320, the examples in which the natural language model 2320 generates explanation information of the CTI intelligence detected by the first CTI device 1000 or a CTI query answer may follow the embodiment of the natural language model 2320 disclosed below.

Although not shown in this figure, the first CTI device 1000 may further include a threat intelligence management module (not shown) that provides visualization information about threat intelligence for monitoring the threat intelligence detected by the detection module 1300.

Based on this analysis information and the natural language model 2320, the threat intelligence management module (not shown) of the first CTI device 1000 can derive threat elements and produce protection measures and visualization information for assets including IT assets, OT infrastructure, and IoT devices connected to the network.

The threat intelligence management module (not shown) of the first CTI device 1000 provides a means for establishing and monitoring management information for various assets associated with network traffic.

For example, the threat intelligence management module (not shown) of the first CTI device 1000 can establish a list of managed assets and detailed information related to threat intelligence. The embodiments of the first CTI device 1000 can establish the IP/MAC address, vendor and type information, model serial information, and firmware information of each asset, and monitor the software version.

The threat intelligence management module (not shown) of the first CTI device 1000 can establish a network map of the managed assets and provide visualization information through the monitoring module 1800.

The threat intelligence management module (not shown) of the first CTI device 1000 can identify the vulnerabilities of each managed asset and provide the corresponding vulnerability information through the monitoring module 1800.

In the embodiment of this figure, the first CTI device 1000 may include a database 2700 for storing data and a processor for processing network data.

The processor within the first CTI device 1000 can process commands that analyze data according to a protocol or application data within the network traffic, transmit a query request regarding cyber threat information related to the analyzed data to the natural language model 2320, and receive and provide a detailed analysis result and explanation information for the cyber threat information according to the query request from the natural language model 2320.

The first CTI device 1000 may also be implemented as software that stores and executes the above computer-executable commands.

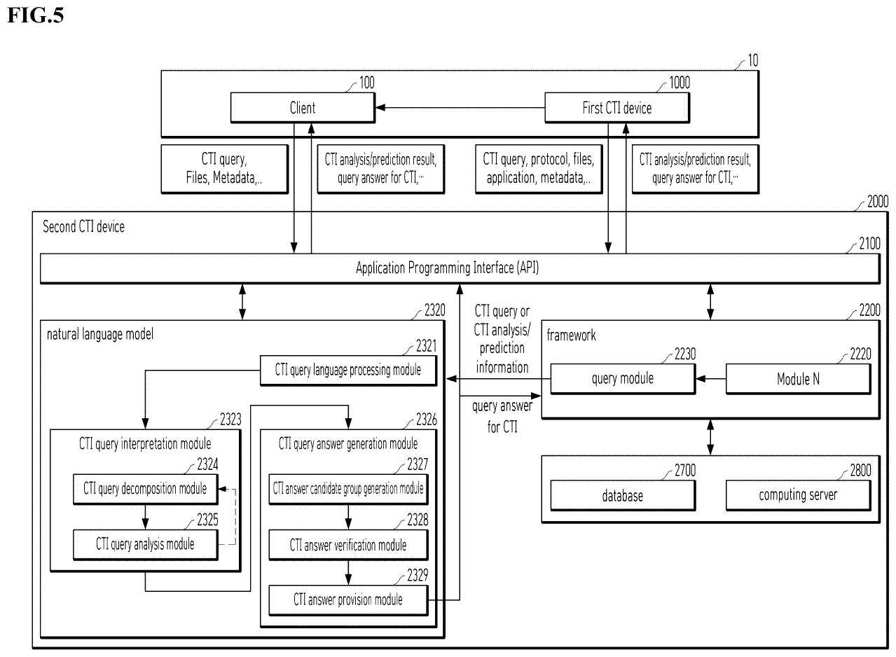

FIG. 5 discloses an example in which a first CTI device and a second CTI device interwork as an embodiment of cyber threat information processing apparatuses according to an embodiment.

The Application Programming Interface (API) 2100 of the second CTI device 2000 may receive a file, a cyber threat information (CTI) analysis request related to the file, or a query related to CTI from the client system 10.

The framework 2200 of the Application Programming Interface (API) 2100 may include a plurality of analysis modules or prediction modules. For example, it has been disclosed above that the framework 2200 can perform static analysis, dynamic analysis, deep analysis, mild-dynamic analysis, and the like according to the input file using an AI engine. Here, any module that performs such analysis or prediction is indicated as Module N 1219.

When the framework 2200 receives a file from the client system 10, it can obtain assembly-level binary data through disassembling. The framework 2200 can perform analysis of functions related to maliciousness, analysis of attack behavior or attack technique, and analysis of attack group, and analysis of a sequence of binary data blocks (hereinafter referred to as an instruction sequence) according to the call association relationship of functions included in the binary data, based on this.

When the input file is a non-executable file such as a document file, the framework 2200 can analyze the maliciousness, attack behavior or attack technique, and attack group of the file.

The computing server 2800, whether an on-premise server or a cloud server, performs crawling to collect web pages on the Internet, and the framework 2200 can perform analysis of the maliciousness, attack behavior or attack technique, and attack group of the collected web pages.

The database 2700 can classify and store results analyzed by the framework 2200 of the second CTI device 2000, for example, functions of assembly code generated during file analysis, maliciousness of functions, hash codes, instruction sequences, static analysis, dynamic analysis, mild-dynamic analysis, prediction analysis results, maliciousness included in partial tags of web pages, information on attack techniques corresponding to MITRE ATT&CK, attack behavior, and attack groups, attack campaigns related to files, attack countries, attack industries, and the like.

Meanwhile, when the client system 10 makes a CTI natural language query along with an analysis request for cyber threat information (CTI) regarding a specific file, web page, or the like, the query module 2230 of the framework 2200 transmits it to the natural language model 2320 of the artificial intelligence processing module 2300.

The natural language model 2320 may be a natural language model (NLP), a large language model (LLM), or a language model based on Transformer technology, or it may be a smaller Large Language Model (sLLM) related to cyber threats or security.

The client system 10 may request CTI analysis or prediction related to a file, or may request a general natural language CTI query unrelated to a file.

Accordingly, the query module 2230 generates a CTI query or a supplementary query based on the cyber threat information (CTI) analyzed by the framework 2200 and transmits it to the natural language model 2320.

If the client system 10) requests a CTI query unrelated to a file, the query module 2230 transmits the CTI query to the natural language model 2320.

A CTI query language processing module 2321 can analyze the CTI query using a parsing technology included in the CTI query.

The CTI query processed by the CTI query language processing module 2321 is transmitted to a CTI query interpretation module 2323.

The CTI query interpretation module 2323 can perform a function of classifying a question and recognizing a sub-question type and a relationship between sub-questions based on a sentence structure and meaning of the CTI query processed by the CTI query language processing module 2321.

The CTI query interpretation module 2323 may include a CTI query decomposition module 2324 and a CTI query analysis module 2325.

The CTI query decomposition module 2324 can perform a function of classifying a question and classifying a sub-question type based on a sentence structure and meaning included in the CTI query, and recognizing a relationship between the classified sub-questions.

The CTI query analysis module 2325 can classify a type of the classified sub-question. And the CTI query analysis module 2325 can recognize a core of the question based on a confidence level of a word or phrase that can be replaced by a candidate answer, according to the classified type of the sub-question.

If the CTI query analysis module 2325 has a confidence level at which the core of the question cannot be recognized, the CTI query decomposition module 2324 may be caused to reclassify the sub-question type.

According to the iterative processing of the CTI query decomposition module 2324 and the CTI query analysis module 2325, the CTI query analysis module 2325) can detect and verify a topic of the CTI-related question.

A CTI query answer generation module 2326 can generate all possible answer candidates from structured or unstructured resources based on the CTI question and question classification information. The CTI query answer generation module 2326 may include a CTI answer candidate group generation module 2327, a CTI answer verification module 2328, and a CTI answer provision module 2329.

The CTI answer candidate group generation module 2327 can perform an index and search function from the database 2700 including cyber threat information (CTI) and generate a candidate answer based on the search result. The CTI answer candidate group generation module 2327 generates all possible answer candidates from the database including cyber threat information (CTI) based on the question and question classification information. Here, the database including cyber threat information (CTI) includes the database 2700 of the second CTI device 2000. The CTI answer candidate group generation module 2327 may also collect evidence for the answer candidates from the database 2700 including cyber threat information (CTI). This will be described later below.

The CTI answer verification module 2328 can perform the function of an answer reasoning and generation module and determine and generate the best answer. The CTI answer verification module 2328 determines the rank of the answer candidates by measuring the confidence level of the answer candidates, characterized by the filtered answer candidates and the reasoned answer candidates.

The CTI answer verification module 2328 can filter the answer candidates using inductive, deductive, or abductive reasoning based on the similarity between the query and the answer candidates.

And the CTI answer verification module 2328 can readjust the rank of the answer candidates by comparing the confidence ratio of the answer candidates with a threshold, thereby selecting the optimal CTI answer.

A CTI answer provision module 2329 transmits the CTI answer verified by the CTI answer verification module 2328 to the second CTI device 2000 to provide natural language explanation information for the CTI query answer.

When the client system 10 queries for cyber threat information (CTI) along with a request for cyber threat information (CTI) related to a file or separately, the second CTI device 2000 can provide information on CTI file-related information (maliciousness, hash value, attack technique, attack group, attack campaign, etc.), its natural language explanation, and evidence collected as its basis.

For example, when the client system 10 queries related to the analysis request result of a specific file, information about which MITRE ATT&CK attack technique by which attack group the malicious behavior by the file is, and whether it is connected to which attack campaign (a series of mechanisms of one or more attacks) can be provided as the visualization information exemplified above. And the second CTI device 2000 can provide the natural language explanation generated by the natural language model along with the visualization information, and can also provide valid digital analysis evidence for the analysis result and natural language explanation analysis evidence for the digital analysis evidence.

When the client system 10 queries for cyber threat information (CTI) unrelated to a file, the answer to the CTI query, the natural language explanation for the CTI query generated by the natural language model, and evidence collected as its basis can be provided.

The second CTI device 2000 can provide the cyber threat information (CTI) analyzed or predicted by the framework 2200 and the natural language answer or explanation information for the query of the cyber threat information (CTI) provided by the natural language model 2320 to the client system 10 together.

A physical device 2000, which is the second CTI device 2000 being a computing device, may include the computing server 2800 that includes the database 2700 and a processor.

The processor driving the second CTI device 2000 can receive a cyber threat information (CTI) analysis request for data related to a file from a client, analyze the requested cyber threat information (CTI), and transmit a first cyber threat information (CTI) query generated based on the analyzed cyber threat information (CTI) to the natural language model 2320.

And the processor driving the second CTI device 2000 can provide the analyzed cyber threat information (CTI) and the explanation information of the analyzed cyber threat information (CTI) generated by the natural language model 2320.

When the processor driving the second CTI device 2000 receives a second cyber threat information (CTI) query from the client, it can transmit the second cyber threat information (CTI) query to the natural language model and provide the explanation information for the cyber threat information (CTI) query generated by the natural language model.

The operations performed by the physical device as described above may be executed by a program implemented as software in the embodiments.

As in the disclosed example, the protocol data, application data, file, metadata, and CTI query related thereto analyzed by the first CTI device 1000 from network traffic, or the file received by the client device 100 and the CTI query related thereto, are transmitted to the second CTI device 2000.

The second CTI device 2000 can analyze the CTI characteristics of the file in a plurality of modules within the framework 2200, as exemplified. Separately, the client device 100 can also transmit a CTI query related to a file or the like to the second CTI device 2000.

The CTI characteristics analyzed in the framework 2200 of the second CTI device 2000 are transmitted to the AI engine 2310 of the artificial intelligence processing module 2300.

The AI engine 2310 of the artificial intelligence processing module 2300 can classify additional characteristics of the CTI characteristics analyzed in the framework 2200, such as functions of related assembly code, maliciousness of functions, hash codes, instruction sequences, maliciousness included in partial tags of web pages, information on attack techniques corresponding to MITRE ATT&CK, attack behavior, and attack groups, attack campaigns related to files, attack countries, and attack industries.

Meanwhile, in order to generate explanation information for the CTI characteristics received by the CTI device 2000 or analyzed in a plurality of modules within the framework 2200, the CTI query is transmitted to the natural language model 2320 of the artificial intelligence processing module 2300.

The natural language model 2320 of the artificial intelligence processing module 2300 can generate an answer to the received CTI query and transmit it to the client device 100 or the first CTI device 1000.

The embodiment of this figure discloses a case where the first CTI device 1000 is not equipped with the natural language model 2320. If the first CTI device 1000 includes the natural language model 2320, the first CTI device 1000 can generate an answer to the CTI query or natural language-based explanation information using the internal natural language model 2320 without needing to query the second CTI device 2000 for the CTI intelligence detected from network traffic, and provide it to a user.

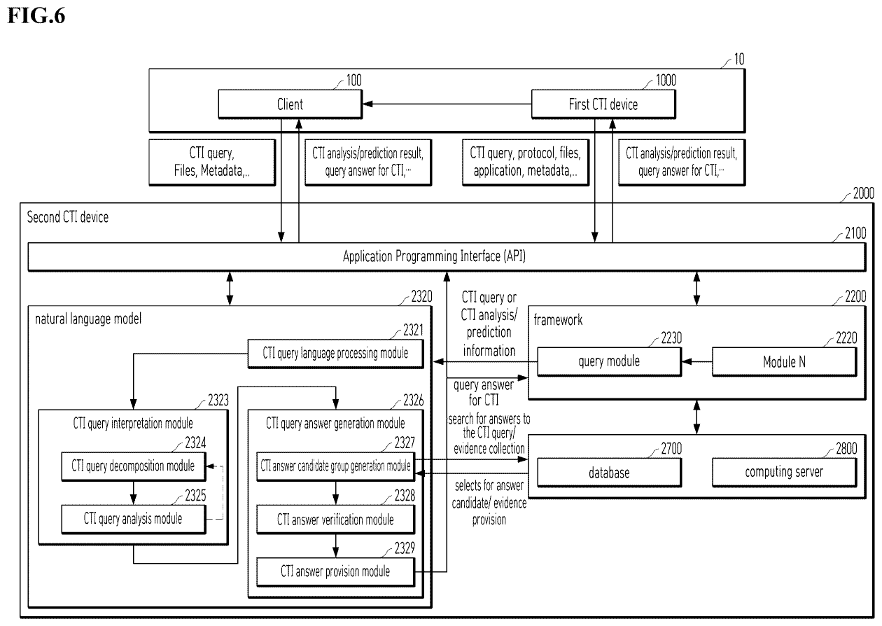

FIG. 6 discloses another example in which a first CTI device and a second CTI device interwork as an embodiment of cyber threat information processing apparatuses.

The Application Programming Interface (API) 2100 of the second CTI device 2000 may receive a file, a cyber threat information (CTI) analysis request related to the file, or a CTI query related to CTI from the client system 10.

The functions of the modules 2220, 2230 within the framework 2200 of the Application Programming Interface (API) 2100 and the crawling function of the computing server 2800, and the like, are as described above.

The database 2700 can classify and store results analyzed by the framework 2200 of the second CTI device 2000, for example, functions of assembly code generated during file analysis, maliciousness of functions, hash codes, instruction sequences, static analysis, dynamic analysis, mild-dynamic analysis, prediction analysis results, maliciousness included in partial tags of web pages, information on attack techniques corresponding to MITRE ATT&CK, attack behavior, and attack groups, attack campaigns related to files, attack countries, attack industries, and the like.

Meanwhile, when the client system 10 makes a CTI natural language query along with an analysis request for cyber threat information (CTI), the query module 2230 of the framework 2200 transmits it to the artificial intelligence-based natural language model 2320. The natural language model 2320 may be a natural language model (NLP) or a large language model (LLM), or it may be a smaller Large Language Model (sLLM) related to cyber threats or security.

The client system 10 may request CTI analysis or prediction related to a file, or may request a general natural language CTI query unrelated to a file. Accordingly, the query module 2230 generates a CTI query or a supplementary query based on the cyber threat information (CTI) analyzed by the framework 2200 and transmits it to the natural language model 2320.

If the client system 10 requests a CTI query unrelated to a file, the query module 2230 transmits the CTI query to the natural language model 2320.

A CTI query language processing module 2321 can analyze the CTI query using a parsing technology included in the CTI query.

The example in which the CTI query analysis module 2325 detects and verifies the topic of the CTI-related question according to the iterative processing of the CTI query decomposition module 2324 and the CTI query analysis module 2325 is exemplified above.

A CTI query answer generation module 2326 can generate all possible answer candidates from structured or unstructured resources based on the CTI question and question classification information. The CTI query answer generation module 2326 may include a CTI answer candidate group generation module 2327, a CTI answer verification module 2328, and a CTI answer provision module 2329.

The CTI answer candidate group generation module 2327 can perform an index and search function from the database 2700 including cyber threat information (CTI) and generate a candidate answer based on the search result. The CTI answer candidate group generation module 2327 generates all possible answer candidates from the database including cyber threat information (CTI) based on the question and question classification information.

Here, the database including cyber threat information (CTI) includes the database 2700 of the second CTI device 2000.

The CTI answer candidate group generation module 2327 may also collect evidence for the answer candidates from the database 2700 where the cyber threat information (CTI) is stored.

The CTI answer candidate group generation module 2327 performs an index and search function for various document files. The CTI answer candidate group generation module 2327 generates candidate answers from the input query using search results from various knowledge databases including the database 2700.

The CTI answer candidate group generation module 2327 generates all possible answer candidates from various resources including the database 2700 based on the question and question classification information. And the CTI answer candidate group generation module 2327 selects a candidate answer using abductive or inductive evidence of the answer type or/and self-evident principles that can constrain the answer, based on the evidence collected from the resource. That is, the CTI answer candidate group generation module 2327 can collect evidence for the answer from resources including the database 2700, verify the answer candidate by verifying self-evident principles for the context, and generate the answer. Thus, the CTI answer candidate group generation module 2327 can search for answers to the CTI query in the database 2700 and collect digital evidence or basis for the CTI query answer.

Since the database 2700 classifies and stores the already analyzed cyber threat information (CTI), when the CTI answer candidate group generation module 2327 generates the answer candidate group, it can provide search data for generating the candidate group. In addition, when the CTI answer candidate group generation module 2327 selects an answer candidate from the answer candidate group, the database 2700 can provide evidence or a basis for the answer candidate based on the stored cyber threat information (CTI).

The CTI answer verification module 2328 can perform the function of an answer reasoning and generation module and determine and generate the best answer. The CTI answer verification module 2328 determines the rank of the answer candidates by measuring the confidence level of the answer candidates, characterized by the filtered answer candidates and the reasoned answer candidates.

The CTI answer verification module 2328 can filter the answer candidates using inductive, deductive, or abductive reasoning based on the similarity between the query and the answer candidates. And the CTI answer verification module 2328 can readjust the rank of the answer candidates by comparing the confidence ratio of the answer candidates with a threshold, thereby selecting the optimal CTI answer.

A CTI answer provision module 2329 transmits the CTI answer verified by the CTI answer verification module 2328 to the second CTI device 2000 to provide natural language explanation information for the CTI query answer.

The example in which the second CTI device 2000 provides natural language explanation information for the requested CTI analysis result and CTI query answer, or provides natural language explanation information for the CTI query, was disclosed above.

A physical device 2000, which is the second CTI device 2000 being a computing device, may include the computing server 2800 that includes the database 2700 and a processor.

The processor driving the second CTI device 2000 can receive a cyber threat information (CTI) analysis request for data related to a file.

The processor driving the second CTI device 2000 can analyze the requested cyber threat information (CTI) and search for a candidate answer group for a first CTI query generated based on the analyzed cyber threat information (CTI) from the database 2700.

Based on the searched result, the processor can determine the candidate answer group and provide a natural language explanation for the first cyber threat information (CTI) query based on the first candidate (optimal candidate) among the determined candidate answer group.

When the processor driving the second CTI device 2000 receives a second cyber threat information (CTI) query from the client system 10, it can search for a candidate answer group for the cyber threat information (CTI) query from the cyber threat information (CTI) database. And the processor can provide explanation information for the cyber threat information (CTI) query generated by the natural language model.

As in the disclosed embodiment, the second CTI device 2000 can be implemented as a physical device including a database that stores cyber threat information and a computing server that processes data.

The processor of the computing server can process an instruction set including instructions for: receiving an analysis or query request for cyber threat information related to data included in network traffic from the first CTI device 1000; generating a detailed analysis result and explanation information for the cyber threat information according to the query request; and providing the generated detailed analysis result and explanation information to the client system.

Furthermore, it may be implemented as software that stores computer-executable instructions that perform the same operations performed by the physical device.

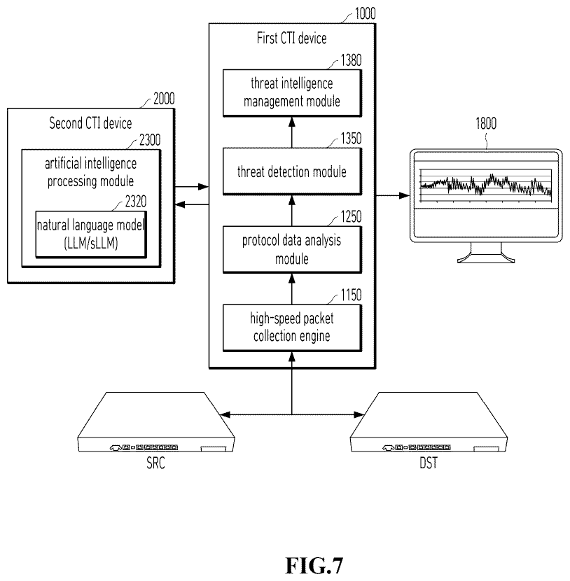

FIG. 7 discloses an example of a cyber threat information processing apparatus according to an embodiment.

The disclosed embodiment may include a first CTI device 1000 and a second CTI device 2000.

The first CTI device 1000 may include a high-speed packet collection engine 1150, a protocol data analysis module 1250, a threat detection module 1350, and a threat intelligence management module 1380. Here, the high-speed packet collection engine 1150 is described as an embodiment of a collection module 1100 of the first CTI device 1000, the protocol data analysis module 1250 is described as an embodiment of an analysis module 1200, and the threat detection module 1350 may be described as an embodiment of a detection module 1300.

The high-speed packet collection engine 1150 can collect packet data included in network traffic between a source (SRC) and a destination (DST). In one or more embodiments, the high-speed packet collection engine 1150 can collect packet data at high speed by polling packets received at a network interface card without using a kernel, using a high-speed processing library.

The protocol data analysis module 1250 can analyze the packet data and extract flow information about the packet data. In one or more embodiments, the protocol data analysis module 1250 can analyze data included in the packet data according to a protocol or an application. In one or more embodiments, the protocol data analysis module 1250 can generate metadata corresponding to the protocol or the application. In one or more embodiments, the flow information may include at least one of an IP and a port of at least one of the source and the destination, a protocol for the network traffic, an application, and metadata.

In one or more embodiments, the flow information may further include at least one of host information and operating system information. Here, the host information may include identification information and version information for a host (e.g., computer, server, device, etc.) including the source and the destination connected to the network. For example, the computing server may include a computing server operated by an organization corresponding to the source or the destination, for example, a computing server corresponding to an internal asset.

In one or more embodiments, the protocol data analysis module 1250 can check a state of the corresponding port to check ports open to the source and the destination and the state of the corresponding port. Here, the open port can be used for network communication, and can be used to check which application-based service is running.

In one or more embodiments, the protocol data analysis module 1250 can identify which application-based service or protocol is running on the source and the destination through the open port.

In one or more embodiments, the protocol data analysis module 1250 can check which computing server operates with which version based on the flow information.

In one or more embodiments, the monitoring target of ASM (Attack Surface Management) is information on internal assets and the internal assets, and may include an application, for example, when a service is directly operated by a computing server corresponding to an IP and the internal asset. In one or more embodiments, the protocol data analysis module 1250 can identify a vulnerability of an asset operated by an organization corresponding to at least one of the source and the destination, or an asset that the organization does not own but belongs to the organization's infrastructure or supply chain (e.g., cloud). In one or more embodiments, when a service is directly operated by a computing server, the monitoring target of ASM may include an application.

The threat detection module 1350 can generate vulnerability information corresponding to the flow information based on vulnerability-related information included in a predefined vulnerability database. In one or more embodiments, the threat detection module 1350 can generate the vulnerability information by performing ASM (Attack Surface Management) using the flow information based on network traffic collection. According to the present invention, potentially attackable ports or vulnerabilities can be found and managed through the ASM.

In one embodiment, the vulnerability information may include at least one of information on the existence of a vulnerability for the flow information, a type of the vulnerability, and contents of the vulnerability. For example, the threat detection module 1350 can determine whether the corresponding port included in the flow information has a vulnerability.

In one or more embodiments, the threat detection module 1350 can generate the vulnerability information by comparing the flow information with an external vulnerability database or a vulnerability database stored in the first CTI device 1000. In one or more embodiments, the vulnerability database conforms to standards such as CVE (Common Vulnerabilities and Exposures) and may include various vulnerability-related information.

In one or more embodiments, the vulnerability-related information included in the vulnerability database may include a CVE (Common Vulnerabilities and Exposures)-ID (identifier) for a vulnerability type, contents of the vulnerability, and severity information of the vulnerability. In one or more embodiments, the vulnerability-related information included in the vulnerability database may include information on various vulnerabilities and risks, including assets that are leaked and exploited.

The threat intelligence management module 1380 can input the vulnerability information to the natural language model 2320 of the artificial intelligence processing module 2300 of the second CTI device 2000 to provide vulnerability explanation information in a natural language form to a user. In one or more embodiments, the second CTI device 2000 may be separately configured external to the first CTI device 1000, or may be included in the first CTI device 1000 and configured integrally. For a detailed description of the second CTI device 2000, refer to the content described above.

In one or more embodiments, the threat intelligence management module 1380 can input at least one of the vulnerability information and a vulnerability analysis query prompt based on the vulnerability information to the natural language model 2320 to provide vulnerability explanation information in a natural language form to the user. In one or more embodiments, the vulnerability analysis query prompt may include content requesting a vulnerability explanation related to the vulnerability information. In one or more embodiments, the vulnerability analysis query prompt may include content requesting generation of an analysis report based on the result of analyzing the vulnerability information and a format of the analysis report. For example, the format of the analysis report may include at least one of an analysis overview, a vulnerability status, vulnerability analysis contents, source information, destination information, payload analysis contents, an analysis conclusion, and recommendations for security reinforcement.

In one or more embodiments, the threat intelligence management module 1380 can transmit a CTI query including the vulnerability information and the vulnerability analysis query prompt to the second CTI device 2000. The CTI query language processing module of the natural language model 2320 included in the second CTI device 2000 can analyze the vulnerability information and the vulnerability analysis query prompt included in the CTI query using a parsing technology.

The CTI query processed by the CTI query language processing module can be transmitted to a CTI query interpretation module, and the CTI query interpretation module can classify a question and classify a type of the classified question based on a sentence structure and meaning of the vulnerability analysis query prompt processed by the CTI query language processing module. In addition, the CTI query language processing module can recognize a core of the question based on a confidence level of a word or phrase that can be replaced by a candidate answer, according to the classified type of the question.

A CTI query answer generation module can generate all possible vulnerability answer candidates from structured or unstructured resources based on the vulnerability information, the vulnerability analysis query prompt, and the question classification information. In addition, the CTI query answer generation module can determine and generate the best answer including vulnerability explanation information, characterized by filtered answer candidates and reasoned answer candidates among all vulnerability answer candidates. In addition, the CTI query answer generation module can provide a CTI answer including the generated natural language vulnerability explanation information to the first CTI device 1000.

In one or more embodiments, the threat intelligence management module 1380 can provide information on the corresponding vulnerability contents and vulnerability measures to the user by visualizing it through the monitoring module 1800.

For example, the natural language model 2320 may include various technology-based language models such as NLP (natural language process), large language model (LLM), and Transformer.

In one or more embodiments, when only the confirmed vulnerability information is simply provided, there is a problem that it is difficult to intuitively check what effect the actual vulnerability information has on the vulnerability and how dangerous it is. Therefore, according to the one or more embodiments, by inputting such vulnerability information to the natural language model 2320, it can provide a natural language explanation to the user as to how dangerous the vulnerability is and what measures are necessary.

In one or more embodiments, the threat intelligence management module 1380 can train the natural language model 2320 using a Question-Answer Instruction generated by utilizing the vulnerability information and the vulnerability information. Here, the Question-Answer Instruction refers to data for the natural language model 2320 to be trained, and this data consists of various Questions and various natural language Answers to the questions based on the vulnerability information. In one or more embodiments, the Question-Answer Instruction may include a dataset for the natural language model 2320 to generate an answer to a question.

In one or more embodiments, the first CTI device 1000 can use data and applications stored in a separate storage/database under the control of a computing server in charge of data processing. Here, the storage primarily stores data using a hard disk or SSD, and the database manages structured data and can perform operations such as search and modification. At this time, the functions performed by the first CTI device 1000 can be performed by the processor of the computing server.

According to one or more embodiments of the present disclosure, by performing ASM, a vulnerability of an asset can be identified to perform application of security control and reinforcement of cyber security strategies and policies for the asset. In one or more embodiments, by identifying a vulnerability of an asset, reinforcement of cyber security strategies and policies for the asset, such as application of security control (e.g., operating system or software patch, etc.), setting and discarding security standards for unknown or unmanaged assets, and removal of malicious assets, can be performed.

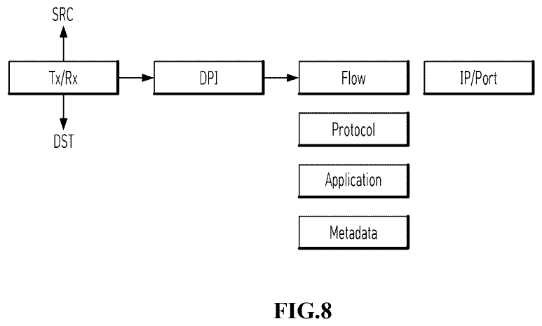

FIG. 8 discloses an embodiment of performing active ASM based on network traffic collection.

In one embodiment, the first CTI device 1000 may acquire network traffic transmitted by a source and a destination. And, the first CTI device 1000 may perform DPI (Deep Packet Inspection) analysis on packet data included in the acquired network traffic to generate flow information.

In this case, DPI can deeply analyze packet data on a network to identify a protocol or an application for the packet data or to collect metadata. On the basis of protocols, applications identified, or metadata collected, through DPI, security vulnerabilities, maliciousness, and abnormal traffic can be detected. For more detailed information, the above-mentioned disclosure may be referred.

In one embodiment, the flow information may include at least one of an IP or a port of the source or the destination, and at least one of a protocol, an application, or metadata for the network traffic. Accordingly, the first CTI device 1000 can identify, through the flow information, which source and destination use which protocol and which application on the basis of which IP and which port.

In one embodiment, the first CTI device 1000 may provide vulnerability information corresponding to the flow information. That is, elements having a high possibility of external attacks can be identified, and vulnerabilities for the elements can be preliminarily examined and managed.

That is, in a conventional ASM, when all network IP ranges are input, ports and IPs are scanned one by one to check which ports are open and which vulnerabilities exist, and in such a case, network resource consumption is severe, and if the input IP range is incorrectly entered, a problem of scanning an external third-party network may occur, and if an actual port or service is not open at the time of scanning, a problem may occur in that scanning cannot be performed. In addition, scanning may not be properly performed due to a firewall, network configuration, and the like.

Accordingly, according to the present disclosure, without needing to perform a network scan, the first CTI device 1000 may receive network traffic and identify a flow, a protocol, and an application from packet data, and may cumulatively manage which port and which protocol each IP has and which service it provides.

In one embodiment, when, in a first handshaking between a source and a destination, that is, when this session is first created, the first several bytes of a specific number are checked, a version of a server (a server providing content service) of the corresponding port being serviced by the corresponding application through the corresponding protocol can be checked. In one embodiment, the bytes may include bytes of packets transmitted and received in handshaking for communication between the source and the destination. In this case, in a handshaking process of establishing a session, a specific pattern of the bytes can be determined by analyzing the first specific number (for example, N) of bytes (or packets), and flow information such as a server or a service corresponding to the specific pattern can be identified. In one embodiment, by analyzing the first several bytes of a specific number included in a per-service banner (Banner) message or a Hello message transmitted and received between the source and the destination, at least one of server identification information and a server version can be checked. In this case, information of a counterpart server can be obtained in the course of handshaking.

When such metadata is extracted, it is possible to check, by comparison with a vulnerability database, which vulnerabilities a server that actually provides a service has and to provide the result.

As such, according to the present disclosure, even without performing a network scan, an effect equivalent to performing a network scan can be obtained from packet data by checking packet data transmitted and received. In one embodiment, after identifying a system or a service with a high possibility of attack, DPI may be performed to deeply analyze traffic to the system or service to detect and respond to security threats. In addition, security vulnerabilities in regions with a high possibility of attack identified through ASM may be verified and supplemented through actual traffic analysis by DPI. In one embodiment, threats to points identified by ASM may be analyzed and detected by DPI, and explanations about points detected after analysis by DPI may be supplemented by ASM.

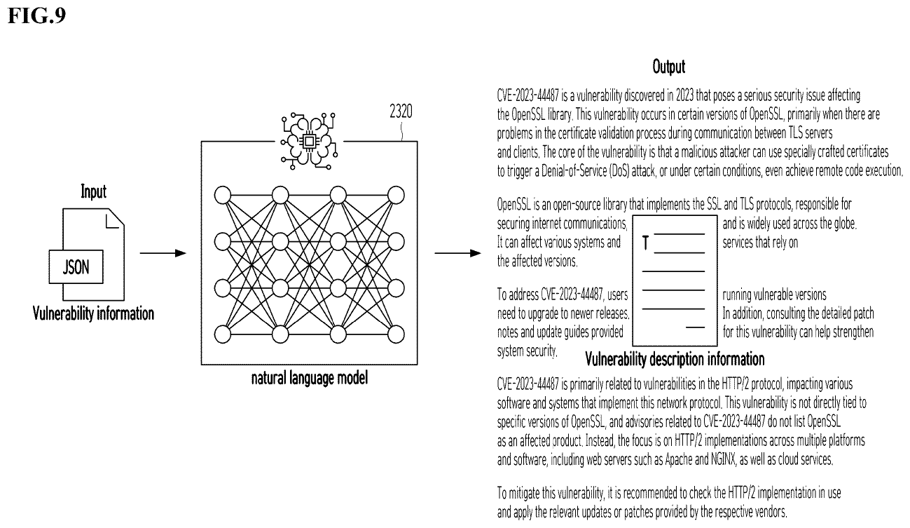

FIG. 9 discloses an embodiment of providing vulnerability contents and countermeasures identified by an ASM technique.

A natural language model 2320 in this figure can receive as input a JSON file including vulnerability information configured in a text format. Here, a JSON file is a format capable of including structured data and can be used to represent various kinds of information.

In one embodiment, the JSON file may include a field containing text and an object describing questions and additional context. In one embodiment, the JSON file may include vulnerability information including a standardized CVE ID.

For example, the JSON file may include at least one of session information, open ports of the source, service information, operating system, vulnerability ID information (for example, CVE ID), open ports of the destination, service information, operating system, vulnerability ID information, session event information, collected file analysis information, malware match information (for example, Yara rules), anti-virus detection information, or AI-based external threat detection information. In the present disclosure, a format of a file input to the natural language model 2320 may be variously configured and is not limited thereto.

In one embodiment of the present disclosure, the natural language model 2320 to which a JSON file including vulnerability information is input may output vulnerability explanatory information described in a text form. For example, when vulnerability information of CVE-2023-44487 for 10.10.4.111 TCP 443 included in flow information is input to the natural language model 2320, an explanation of the CVE-2023-44487 vulnerability and measures for remediating the vulnerability may be output in natural language.

In one embodiment, predefined Question-Answer Instructions (for example, input sentences) may be used to train the AI-based natural language model 2320 that outputs vulnerability explanatory information. In one embodiment, the Question-Answer Instructions may include explanations and questions for a specific vulnerability problem so that the natural language model 2320 can understand and explain a specific type of vulnerability. In one embodiment, the Question-Answer Instructions may include at least one of a sentence representing an actual vulnerability or an actual vulnerability report format. By training the natural language model 2320 using such Question-Answer Instructions, the natural language model 2320 can recognize various vulnerability types and provide vulnerability explanatory information.

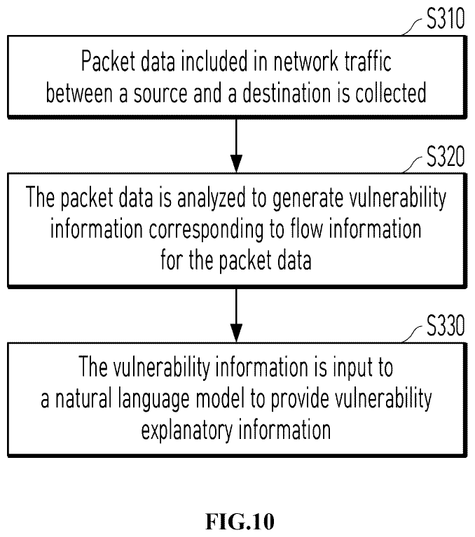

FIG. 10 discloses an embodiment of a method for processing cyber threat information.

Packet data included in network traffic between a source and a destination is collected (S310). In one embodiment, packet data can be collected at high speed by polling packets received at a Network Interface Card by using a high-speed processing library without using a kernel. For a detailed description thereof, reference may be made to the descriptions given with respect to FIG. 7.

The packet data is analyzed to generate vulnerability information corresponding to flow information for the packet data (S320). In one embodiment, the vulnerability information may include a standardized CVE (Common Vulnerabilities and Exposures) ID (identifier) corresponding to the flow information. For a detailed description thereof, reference may be made to the descriptions given with respect to FIGS. 7 to 9.

The vulnerability information is input to a natural language model to provide vulnerability explanatory information (S330). In one embodiment, the vulnerability explanatory information may include at least one of vulnerability content information and vulnerability remediation information in a natural language form. In one embodiment, before step S330, the natural language model may be trained on the basis of at least one of vulnerability information and Question-Answer Instructions generated by using the vulnerability information. For a detailed description thereof, reference may be made to the descriptions given with respect to FIGS. 7 to 9.

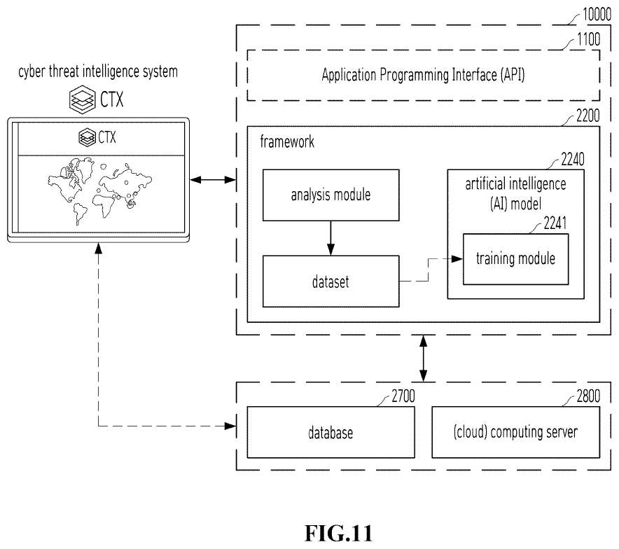

FIG. 11 illustrates another embodiment of an apparatus for processing cyber threat information.

The embodiment of an apparatus for processing cyber threat information 10000 can be provided in real time with feed data supplied by a cyber threat intelligence system.

The embodiment of an apparatus for processing cyber threat information 10000 may include an Application Programming Interface (API) 1100 and a framework 2200.

In this case, the embodiment for processing cyber threat information 10000 does not necessarily require an essential connection with the API 1100 in order to be provided in real time with feed data supplied by the cyber threat intelligence system. That is, the embodiment for processing cyber threat information 10000 may ollect feed data by directly connecting to a storage, for example, a database 2700, in order to be provided with the feed data in real time.

In addition, the framework 2200 may include an analysis and prediction module and an artificial intelligence (AI) model 2240. The embodiment for processing cyber threat information 10000 may utilize already classified malicious code included in the database 2700) or pattern code of stored malicious code. For example, the database 2700 may store sample data, functions, or result information, and may store ASM files and JSON files converted from input files.

In one embodiment, the database 2700 may store, in the form of metadata generated in advance, samples of feed data. That is, the embodiment for processing cyber threat information 10000 may store, in the database 2700, feed data as soon as it is provided in real time with the feed data supplied by the cyber threat intelligence system.

In one embodiment, the apparatus for processing cyber threat information 10000 may collect feed data supplied by the cyber threat intelligence system, analyze it through an analysis module, and construct a dataset.

More specifically, the analysis module may construct a training dataset for the AI model 2240 by using feed data collected according to a preset period. For example, the embodiment for processing cyber threat information 10000 may collect first feed data from Mar. 1, 2024 to Mar. 31, 2024 and construct a training dataset for the AI model by using the first feed data on Apr. 1, 2024. Here, the target AI model corresponds not only to an AI model included inside the apparatus for processing cyber threat information 10000 but also to an AI model for an external system.

In one embodiment, the constructed dataset is delivered to a training module 2241 in the AI model 2240, and the AI model 2240 may learn by using the dataset.

At this time, in order for the AI model 2240 to properly learn, it is necessary to maintain a balance in the number of data for each label. For example, learning data in which a ratio of normal file data to malicious file data maintains a 5:5 balance may be most ideal.

In addition, it is ideal that the learning data include various types of data, and duplicate data need to be removed. At this time, a distribution of data types should appear uniform. For example, when there are features A, B, and C, if most of the data are composed of feature A and feature B, this means that the distribution of data types is not uniform. This causes the learning data to be biased toward specific features, which may act as noise in the model's learning. Accordingly, the data need to be configured so that each feature is evenly distributed. In addition, duplicate data may include not only files having the same hash value but also files having different hash values while having the same content composition.

More specifically, in the case of duplicate data, when duplicate data are distinguished only by hash values, there is a limitation in that, although hash values are not identical, files having the same content composition included in the data may be included.

Accordingly, a sampling method for removing duplicate data and making the data distribution uniform is required.

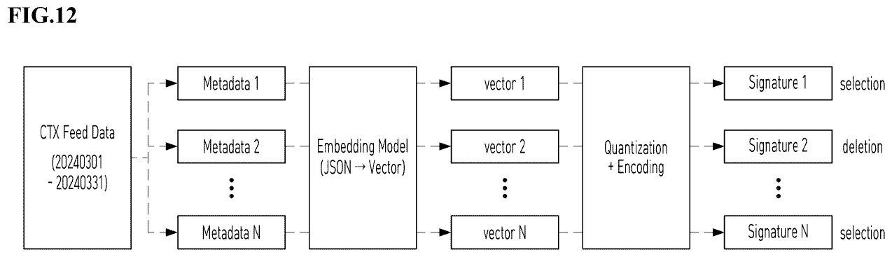

FIG. 12 illustrates an embodiment of a method for processing cyber threat information.

This figure describes a sampling method by which the above-described embodiments for processing cyber threat information removes duplicate data and makes the data distribution uniform.

In one embodiment, the cyber threat information processing method may, as a primary step for constructing learning data and removing duplicate data, use a method of removing sample data having the same hash value. However, in this case, there is a drawback in that, although completely identical samples can be determined as duplicate data and removed, sample data slightly modified for detection evasion but essentially identical cannot be removed.

And, an embodiment of the cyber threat information processing method may use a method of removing sample data based on fuzzy hash in order to construct learning data excluding duplicate data. This removes duplicate data by calculating a fuzzy hash on the basis of byte values in binary samples and removing sample data having high similarity. However, in this case, I/O operations for downloading sample data are required, a high computational load is required for fuzzy hash calculation, and there is a drawback in that characteristics of attack campaign information provided by a cyber intelligence system cannot be fully reflected.

The embodiment that improves such drawbacks may remove duplicate data from collected feed data through an embedding model and quantization and encoding processes. More specifically, feed data provided to the embodiment by the cyber intelligence system may include at least one of information on a threat type (for example, backdoor, ransomware, etc.), information on an attack technique used, information on an attack group, or information on an attack industry.

In one embodiment, the cyber threat information processing method may convert first feed data provided from the cyber intelligence system into a first vector representation.

More specifically, information of one piece of feed data (metadata) is stored in a JSON data format.

In one embodiment, the cyber threat information processing method may convert one JSON data into one vector representation by using an embedding model.

More specifically, the cyber threat information processing method may convert feed data into vector representations by using an embedding model generated by learning feed data supplied by a cyber threat intelligence system. In one embodiment, the embedding model used is characterized by being generated by learning cyber threat information analysis data for files. Here, cyber threat information analysis data for files that the embedding model learns correspond to data obtained by analyzing feed data collected by cyber threat information intelligence. In addition, the embedding model used may include a transformer-based model.

For example, the cyber threat information processing method may convert first to nth JSON metadata into first to nth vectors by using the embedding model. Here, the converted vectors correspond to vectors composed of real numbers of N dimensions.

In one embodiment, the cyber threat information processing method may apply a quantization technique to the converted vectors to quantize them, encode them into strings, and extract signature strings. At this time, since the encoded strings are generated on the basis of embedding vectors, similar JSON metadata has similar vectors.

That is, vectors corresponding to similar JSON metadata are converted into the same signature string after undergoing quantization and string encoding processes. For example, a hash value may be extracted as a signature string through vector quantization and string encoding.

By using the converted signature strings, the embodiment may determine that a set of samples having the same signature string are all similar and regard them as duplicate data. Accordingly, the embodiments of the cyber threat information processing method may select one representative sample data and remove the remaining sample data.

In one embodiment, the cyber threat information processing method may remove sample data determined to be duplicate data and configure all finally remaining sample data as a dataset.

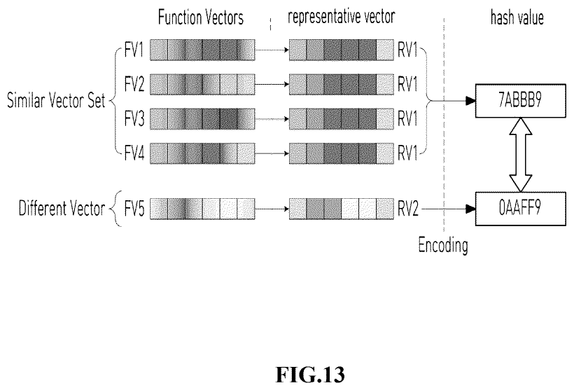

FIG. 13 discloses a quantization technique used by a method for processing cyber threat information according to an embodiment.

This figure describes a vector quantization technique used in a sampling method performed by a cyber threat information processing apparatus in order to remove duplicate data.

In one embodiment, the cyber threat information processing apparatus may perform vector quantization on converted vectors. In one embodiment, the cyber threat information processing apparatus may perform vector quantization that converts a vector including continuous feature values (e.g., real numbers) into a vector including discrete feature values (e.g., integers). Here, a vector including discrete feature values on which vector quantization has been performed may denote a representative vector.

In addition, the cyber threat information processing apparatus may perform encoding that converts feature values of a vector including discrete feature values into a hash value.

For example, similar vectors (Similar Function Vectors) (e.g., FV1 to FV4) included in a similar vector set may have vector quantization performed thereon and thus be converted into the same representative vector (e.g., RV1), and the same hash value, 7ABBB9, may be produced. In contrast, a different vector (Different Function Vector) (e.g., FV5) may have vector quantization performed thereon and thus be converted into a representative vector (e.g., RV2), and a hash value, 0AAFF9, may be produced.

That is, it can be seen that the representative vector of the different vector and the representative vector of the similar vectors are different, and the hash values corresponding thereto are also different. In other words, the embodiment of the cyber threat information processing apparatus may convert similar vectors into the same representative vector through vector quantization. In this case, the same representative vector may have the same hash value.

In other words, the embodiment of the cyber threat information processing apparatus may quantize continuous vectors into representative vectors of a finite set through vector quantization.

That is, a representative vector may denote a quantized vector of functions (that is, a function to be analyzed and a function to be compared).

Quantized vectors are codebook vectors or centroids, which serve as representative vectors among vectors and can provide a compressed representation of data while expressing a certain amount of information.

Accordingly, no model training/update process is required, and a search query may be defined so as to retrieve only functions having the same representative vector.

Ultimately, a hash value may be defined. In a conventional method, tagging is performed on the basis of a label via a classification model and candidate functions having the same tag are searched, and thus the number of candidates to be compared is excessively large and computational complexity is high. However, in the embodiments, only groups of function candidates having similar vectors need to be compared, so computational complexity is low and similar search can be efficiently performed.

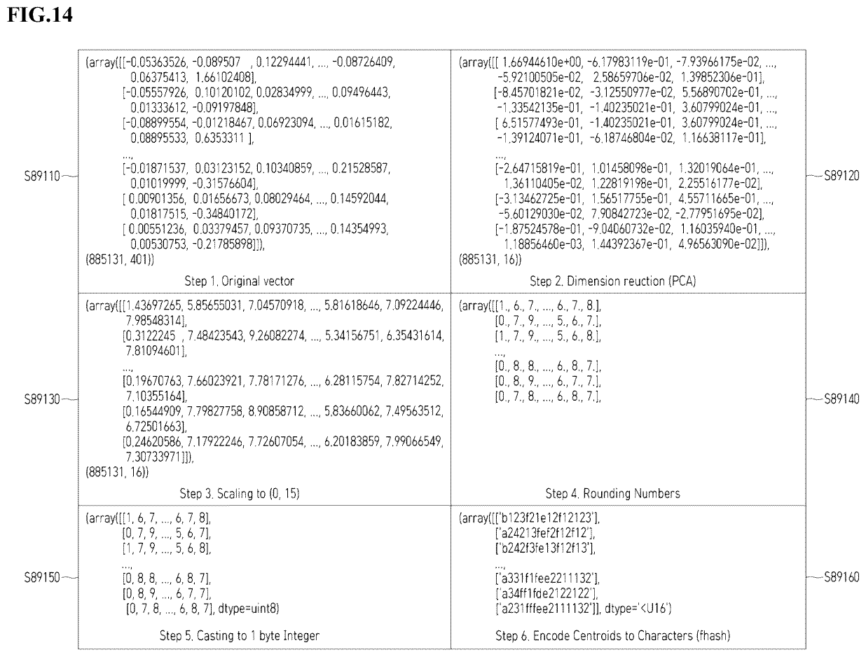

FIG. 14 discloses a quantization technique used by a method for processing cyber threat information according to an embodiment.

This figure describes a vector quantization technique used in a sampling method performed by the embodiment in order to remove duplicate data.

In one embodiment, the cyber threat information processing apparatus may perform vector quantization on vectors. Specifically, the embodiment of the cyber threat information processing apparatus may acquire a vector including continuous feature values (S89110).

The embodiment may perform dimensionality reduction that reduces the dimension of a multidimensional dataset composed of the continuous feature values included in the vector and reconstructs the dataset as a vector having a reduced dimension (S89120). For example, a 401-dimensional vector may be reduced to 16 dimensions through PCA.

And the embodiment may perform scaling that expands each feature value of the dimension-reduced vector into a predetermined range (S89130). For example, each feature value may be expanded into a [0,15] range (16 intervals).

In addition, the embodiment may perform rounding on each feature value of the scaled vector (S89140). For example, a feature value of 1.43697265 may be rounded and converted into 1.

In addition, the embodiment may convert the feature values of the rounded vector from a continuous type into a discrete type (S89150). For example, a feature value of a real-number type may be converted into a feature value of an integer type of 1 byte.

In addition, the embodiment may convert each feature value of the vector converted into an integer type into a hash value (S89160). In one embodiment, the hash value may be represented as a string. For example, the hash value may include b123f21e12f12123.

In an experimental dataset, 274,572 hash values may be derived from a total of 885,131 functions. Accordingly, a reduction rate of 68.97% can be confirmed.

In one embodiment, similarity between vectors may be calculated in a cluster having the largest number of identical hash values, and statistical values may be extracted. For example, the similarity may include a cosine distance between vectors.

In one embodiment, referring to <Table 1>, the minimum, maximum, and quartile values are all identical, which may indicate that all correspond to the same function. Accordingly, for example, when a search is performed on the basis of hash values according to vector quantization of the present invention, it can be confirmed that the number of functions to be compared is reduced from 6,567 to 17 (0.259%).

TABLE 1

| Stat. | 0% | 25% | 50% | 75% | 100% | Mean | Std. |
|---|---|---|---|---|---|---|---|
| Value | 6.66e−16 | 6.66e−16 | 6.66e−16 | 6.66e−16 | 6.66e−16 | 6.66e−16 | 0.0 |

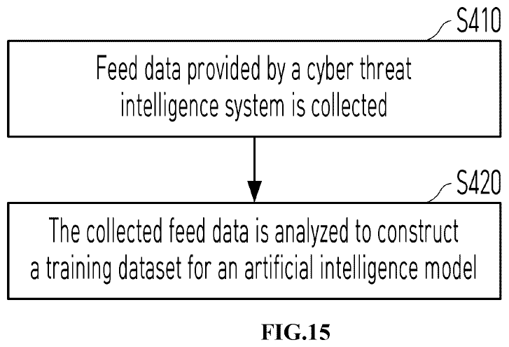

FIG. 15 discloses an example of a method for processing cyber threat information according to an embodiment.

In one embodiment, the cyber threat information processing method may collect feed data provided by a cyber threat intelligence system (S410).

In one embodiment, the cyber threat information processing method may analyze the collected feed data and construct a training dataset for an artificial intelligence model (S420). In one embodiment, in order to construct the training dataset, the cyber threat information processing method may convert the feed data into vectors through an embedding model. In this case, the feed data may include 1^{st} (first) to n-th JSON metadata, where n is an integer. In one embodiment, when the feed data are converted into vectors through the embedding model, 1^{st} (first) to n-th JSON metadata are converted into first to nth vectors.

In one embodiment, the cyber threat information processing method may convert the converted vectors into signature strings through a vector quantization process. In this case, the vector quantization process may include an encoding process of converting the converted vectors into hash values including discrete feature values on which vector quantization has been performed.

In one embodiment, the cyber threat information processing method may remove duplicate data on the basis of the converted signature strings. In this case, a group of samples having the same signature string may be determined to be all similar, representative sample data may be selected from the determined similar sample group, and the remaining data, except for the representative sample data in the similar sample group, may be removed from the training dataset.

The example of the cyber threat information processing method may vectorize collected feed data through the embedding model, quantize them, and construct a dataset that does not include duplicate data. In conventional methods, because data are determined to be different when only their hash values differ, substantially duplicated data inevitably tend to be heavily included in the dataset.

According to the embodiments, there is an advantage in that duplicate data can be removed in a more rigorous way, thereby constructing a dataset including high-quality sample data.

Hereinafter, examples will be disclosed in which malware analysis data can be easily obtained so as to respond to cyber threats as described above, and datasets specifically requested or technically required can be acquired.

The following embodiments can generate and provide AI training datasets based on Advanced Persistent Threat (APT) intelligence data in order to cope with various malicious activities. On this basis, customers or enterprises can strengthen AI-based cyber threat response and provide high-quality data.

Detailed examples of generating and refining such datasets and providing reliable datasets to customers will be disclosed.

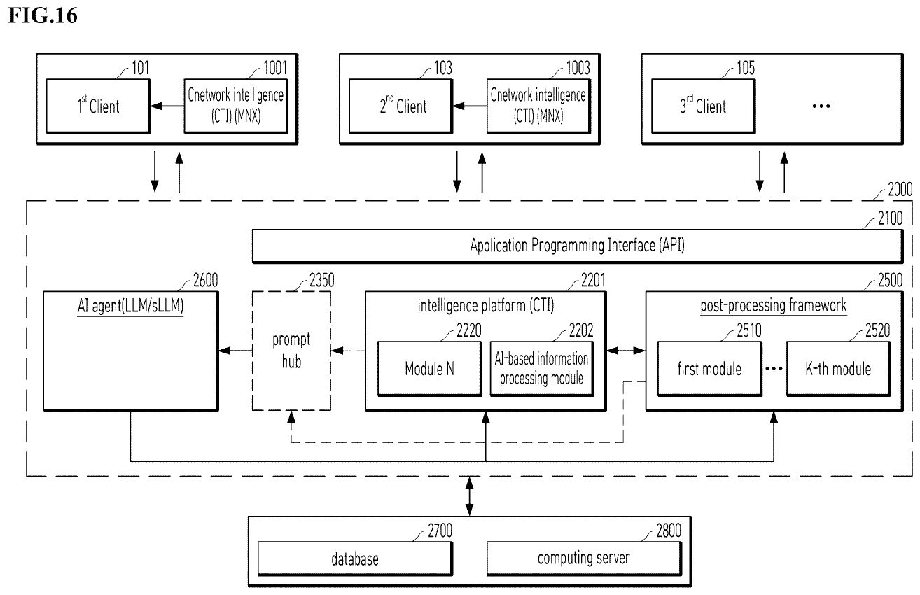

FIG. 16 discloses another example of a cyber threat information processing apparatus that generates AI training data capable of responding to cyber threats.

The disclosed embodiment illustrates an example of a cyber threat information processing apparatus that can be operated by a database 2700 and a computing server 2800. The computing server 2800 may be a virtualized cloud server or an on-premise server and may include one or more nodes or one or more processors.

The disclosed example is a platform based on an Application Programming Interface (API) 2100 and can transmit or receive requests related to cyber threat information from at least one client 101, 103, or 105.

The clients 101, 103, or 105 may obtain analysis or prediction results from network intelligence (CTI) (MNX) devices 1001 or 1003, respectively, that can analyze cyber threat information delivered over a network.

Hereinafter, for components identical to those of the above example, the descriptions of the embodiments disclosed above may be applied as they are.

The network intelligence (CTI) (MNX) devices 1001 or 1003 may follow the example of the first CTI device 1000 disclosed above, respectively.

An intelligence platform (CTI) 2201 may be another embodiment of the framework 2200 included in the second CTI device 2000 disclosed above and may process cyber threat information in a platform form and provide the results. Detailed descriptions thereof have been given above.

For example, the intelligence platform (CTI) 2201 may receive various cyber threat information, files, or queries via the Application Programming Interface (API) 2100 from the clients 101, 103, or 105 or the network intelligence (CTI) (MNX) devices 1001 or 1003, respectively. Then, the intelligence platform (CTI) 2201 may process the received cyber threat information, files, or queries and provide the results to the clients 101, 103, or 105 or the network intelligence (CTI) (MNX) devices 1001 or 1003, respectively.

In this example, the intelligence platform (CTI) 2201 may include an AI-based information processing module 2202 and a plurality of modules that can analyze cyber threat information in various ways. Although the intelligence platform (CTI) 2201 may have multiple analysis modules and each module may analyze or predict various cyber threat information, it is denoted here as Module N 2220. Descriptions of Module N 2220 have been provided above, and thus detailed explanations thereof will be omitted.

The AI-based information processing module 2202 may be the artificial intelligence processing module 2300 disclosed above. A natural language model 2320 included in the artificial intelligence processing module 2300 disclosed above may, in this figure, be a separate AI agent 2600 separated from the intelligence platform (CTI) 2201.

A prompt hub 2350 includes various queries optimized for processing cyber threat information and datasets for optimized questions and answers, and may use these to provide, to the clients 101, 103, or 105, various explanations of results of processed cyber threat information via the AI agent 2600.

For example, the prompt hub 2350 may generate natural language question-and-answer sets on the basis of results of cyber threat information analyzed, generated, or processed by the post-processing framework 2500 described below or the intelligence platform (CTI) 2201.

The prompt hub 2350 may include the functions of the query module 2230 disclosed above. In this figure, the prompt hub 2350 within the second CTI device 2000 is depicted as a module separate from the intelligence platform (CTI) 2201, but the intelligence platform (CTI) 2201 may also include the prompt hub 2350, like the query module 2230 disclosed above.

A post-processing framework 2500 may post-process cyber threat information analyzed or generated by the prompt hub 2350, the AI agent 2600, and the intelligence platform (CTI) 2201, and provide it to the clients 101, 103, or 105.

In this example, the post-processing framework 2500 may include a plurality of modules 2510 or 2520 according to post-processing methods and processing functions for cyber threat information, and is illustrated as a first module 2510 to a K-th module 2520 in this figure.

For example, the post-processing framework 2500 may generate visualization information for various cyber threat information analyzed by the intelligence platform (CTI) 2201, such as a specific malicious activity or an Advanced Persistent Threat (APT), and provide it through the intelligence platform (CTI) 2201.

Information related to queries of the post-processing framework 2500 is delivered to the prompt hub 2350, and the prompt hub 2350 may generate queries regarding the cyber threat information by using the generated question-and-answer database and deliver them to the AI agent 2600.

In this embodiment, the post-processing framework 2500 is described as a framework separate from the intelligence platform (CTI) 2201, but a single framework may be configured such that a plurality of modules perform the respective functions described for the modules.

That is, the post-processing framework 2500 may be configured as a single framework together with the intelligence platform (CTI) 2201 and the framework 2200 disclosed above, or may be divided into a plurality of separate frameworks according to the functions of the modules.

In this example, for convenience, the intelligence platform (CTI) 2201 is indicated as a platform for detecting malware or malicious activities, and the post-processing framework 2500 is indicated as sets of modules that generate datasets by assigning metadata to results detected by the intelligence platform (CTI) 2201 or post-process the detected results in a predetermined manner and provide them to the clients.

Accordingly, as in the example disclosed above, the post-processing framework 2500 may include a module that performs vector quantization used in a sampling method that removes duplicate data from data processed by the intelligence platform (CTI) 2201 and equalizes data distribution. Detailed embodiments thereof have been disclosed above.

The AI agent 2600 may provide, to the clients 101, 103, or 105, a natural language explanation together with related information in response to a cyber threat information query delivered from the prompt hub 2350, directly or via the intelligence platform (CTI) 2201.

Alternatively, the AI agent 2600 may provide such information or explanations back to the post-processing framework 2500, so that the post-processing framework 2500 can regenerate related information.

Meanwhile, the intelligence platform (CTI) 2201 may perform malware or malicious activity analysis on the basis of at least one of various files, queries, hash values of files, or metadata of cyber threat information received from the clients 101, 103, 105 or the network intelligence (CTI) (MNX) devices 1001 or 1003, respectively, or collected by crawling on its own.

The intelligence platform (CTI) 2201 may generate, together therewith, various metadata related to analyzed malware or detected malicious activities.

Metadata of the analyzed cyber threat information may include an analysis completion or update date, a date on which the malicious activity was collected, a date on which the malicious activity was first detected, a date on which the malicious activity was last detected, and hash values of various series of hash functions related thereto.

In addition, the metadata of the analyzed cyber threat information may include a size of a file related to the malicious activity, a type of the file, and tag information related to the malicious activity.

The metadata of the analyzed cyber threat information may include a name of a detection that detected the malicious activity, a name of a file, a type of threat, an attack identifier related to an attack technique, a name given to an attack activity, a tactic related to the attack activity, and site information capable of explaining these.

And, if cyber threat information has been analyzed from a specific file, cyber threat information of a file similar to the specific file and campaign-related Indicators of Compromise (IoCs), that is, compromise indicators that may be common to the corresponding cyber threat incident, may be included in the cyber threat information.

For the cyber threat information analyzed and the metadata generated by the intelligence platform (CTI) 2201, the post-processing framework 2500 may store, in the database 2700, a dataset generated together with the metadata or by adding labeling to the metadata. Depending on the collected cyber threat information, normal data may be stored, or known malicious activity data or new malicious data may be stored.

Examples have been disclosed above in which the framework 2200 or the post-processing framework 2500 receives data analyzed by the intelligence platform (CTI) 2201 as feeding data and constructs an artificial intelligence dataset.

The intelligence platform (CTI) 2201 transmits, to the post-processing framework 2500, detection results of the network intelligence (CTI) (MNX) devices 1001 or 1003, or its own detection results, or results requested by a client.

A first module 2510 of the post-processing framework 2500 may add labeling to the transmitted detection result dataset, store it in the database 2700, and provide it when requested by a client.

For example, when the first module 2510 of the post-processing framework 2500 receives, from the first client 101, a condition including metadata of cyber threat information, it may extract a dataset matching the condition from the database and provide it to the first client 101.

In another example, the first module 2510 of the post-processing framework 2500 may automatically provide a dataset to the intelligence platform (CTI) 2201 or another website according to predetermined conditions or labeling, regardless of a user.

A processor in the computing server 2800 may store, in the database 2700, a labeled dataset according to metadata related to cyber threat information of input data.

The processor in the computing server 2800 may generate, from datasets stored in the database 2700, a dataset corresponding to metadata or query information requested by a client.

The processor in the computing server 2800 may provide the stored or generated dataset to the client according to a purchase scheme selected by the client.

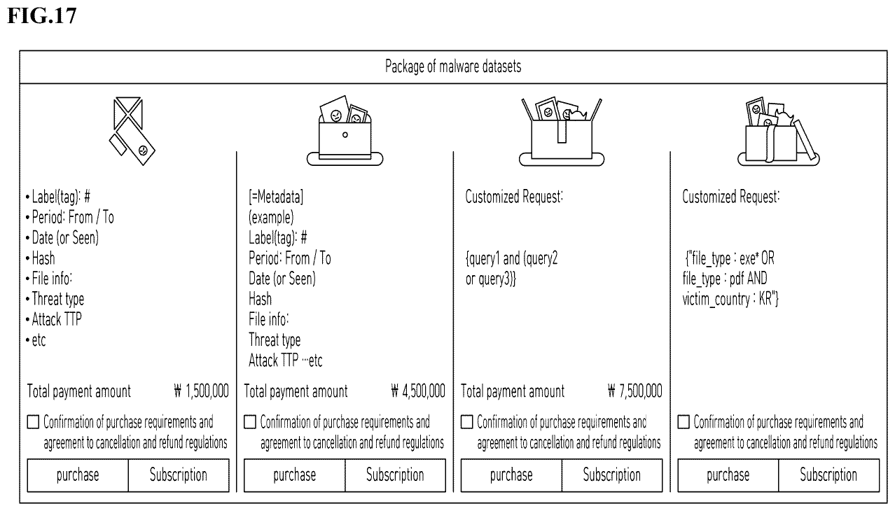

FIG. 17 discloses an example of providing a malware dataset according to an embodiment.

A post-processing framework 2500 of the second CTI device 2000 may automatically generate and store, for a specific period, for example, monthly, datasets related to cyber threat information, and provide them to a client at a specific point in time. For example, the post-processing framework 2500 may, on the first day of each month, generate and store a dataset by applying predetermined labeling to new malicious or normal data collected during the previous month.

The post-processing framework 2500 may provide, to clients via an interface or website, datasets that are automatically labeled and stored according to a specific period. For example, the post-processing framework 2500 may automatically store, every month, a dataset in which related metadata are labeled for data detected by the intelligence platform (CTI).

For example, the metadata may include at least one of an analysis completion or update date of the detected data, a date on which a malicious activity of the input and detected data was collected, a date on which the malicious activity of the input and detected data was first detected, a date on which the malicious activity of the input data was last detected, and hash values of hash functions related to the input data.

In addition, the metadata may include at least one of a size of a file related to the malicious activity of the input data, a type of the file, tag information related to the malicious activity, a name of a detection that detected the malicious activity, a name of the file, a type of threat of the malicious activity, an attack identifier related to an attack technique of the malicious activity, a name given to an attack activity of the malicious activity, a tactic related to the attack activity of the malicious activity, and site information that explains the attack technique.

It may also include at least one of an analysis completion or update date of the input data, a date on which a malicious activity of the input data was collected, a date on which the malicious activity of the input data was first detected, a date on which the malicious activity of the input data was last detected, and hash values of hash functions related to the input data.

A dataset according to labeling may include a normal dataset or a malicious dataset.

For example, the post-processing framework 2500 may automatically generate metadata of malicious files and metadata of normal files that were first collected in the previous month. And the post-processing framework 2500 may provide a file having a specific file name (for example, YYYYMM.tar.gz) to a client via a website or the like.

When the client 101 accesses, the post-processing framework 2500 may provide list information of automatically generated datasets.

The post-processing framework 2500 may, when the client 101 purchases a selected dataset, allow the related dataset to be downloaded, or may send, to a subscription email address of the client 101, an email including a link through which the selected dataset can be downloaded. If the size of the dataset is large, it may be provided by being divided into a plurality of compressed files.

Meanwhile, the client 101 may obtain, according to desired predetermined conditions, a dataset labeled and stored in the database 2700 by the post-processing framework 2500.

In this figure, the dataset in the first column provides metadata related to the generated dataset. That is, for the dataset in the first column, metadata such as a related label (tag), collection period (Period: From/To), collection date or threat observation date (Date (or Seen)), hash value (Hash), related file information (file info), threat type, and attack tactics, techniques, and procedures (Attack TTP) may be provided.

A client may view the metadata of the dataset constructed by the post-processing framework 2500 and purchase or subscribe to and use the related dataset.

The dataset in the second column is an interface through which a client inputs metadata for a dataset required from the post-processing framework 2500 and obtains the corresponding dataset.

A client may input metadata related to cyber threat information of a desired dataset and thereby purchase or subscribe to and obtain a related dataset, such as a malicious dataset. That is, in the embodiment, a customized dataset corresponding to a combination of metadata selected or input by the client may be generated and provided to the client.

The datasets in the third and fourth columns of this figure disclose examples of providing datasets according to conditions of specific queries of a client.

A client may search for types of data and compose queries. For example, keywords included in a query may include core keywords of metadata.

The metadata may include at least one of an analysis completion or update date of input data, a date on which a malicious activity of the input data was collected, a date on which the malicious activity of the input data was first detected, a date on which the malicious activity of the input data was last detected, or a hash value of a hash function related to the input data.

As another example, the metadata may include at least one of a size of a file related to a malicious activity of the input data, a type of the file, tag information related to the malicious activity, a name of a detection that detected the malicious activity, a name of the file, a type of threat of the malicious activity, an attack identifier related to an attack technique of the malicious activity, a name given to an attack activity of the malicious activity, a tactic related to the attack activity of the malicious activity, or site information that describes the attack technique.

For example, the dataset in the fourth column represents one generated by a query composed of a combination of metadata keywords such as “file_type: exe*OR file_type: pdf AND victim_country: KR”.

As such, when a client inputs a combination of metadata or a query in a predetermined format, the post-processing framework 2500 may, by using labeling stored in the database, provide as a search result a dataset that matches the input combination of metadata or query. When a dataset provided according to a client search result is selected, the post-processing framework 2500 may provide to the client a dataset that matches the corresponding metadata.

In the example of this figure, purchase and subscription are illustrated as schemes by which a client obtains a dataset.

When a client purchases a dataset, the post-processing framework 2500 may allow the client to download the related dataset a predetermined number of times.

When a client subscribes to a dataset, the post-processing framework 2500 may generate a dataset corresponding to a requested query or matching dataset and provide it to a user by email or the like at a specific point in time.

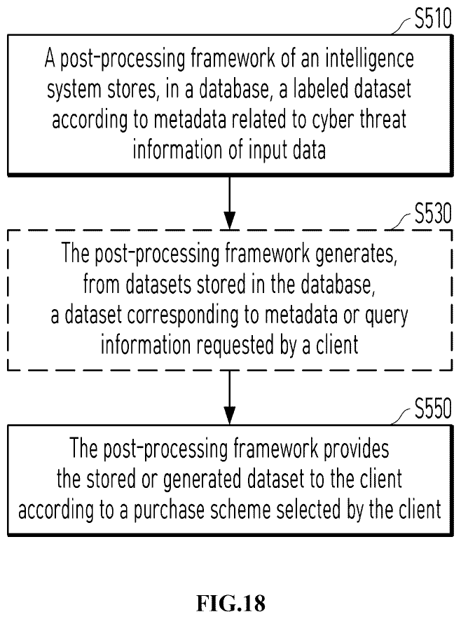

FIG. 18 discloses an example of processing cyber threat information capable of providing a dataset.

A post-processing framework 2500 of an intelligence system stores, in a database 2700, a labeled dataset according to metadata related to cyber threat information of input data (S510).

Examples of generating datasets are illustrated in FIGS. 11 to 17.

The post-processing framework 2500 may generate, from datasets stored in the database 2700, a dataset corresponding to metadata or query information requested by a client (S530).

If a dataset requested by the client does not match a stored dataset, the requested dataset may be generated from stored datasets by using metadata or query information requested by the client. Examples thereof are disclosed in FIGS. 16 and 17. This step may be omitted if the dataset requested by the client has already been stored in the database.

The post-processing framework 2500 provides the stored or generated dataset to the client according to a purchase scheme selected by the client (S550). Detailed examples thereof are disclosed in FIG. 17.

According to the embodiment, malware analysis data can be easily obtained so as to respond to cyber threats as described above, and datasets specifically requested or technically required can be acquired.

According to the embodiment, in order to cope with various malicious activities, AI training datasets can be generated and provided on the basis of Advanced Persistent Threat (APT) intelligence data.

On this basis, customers or enterprises can strengthen AI-based cyber threat response and can provide high-quality data.

According to the embodiment, such datasets can be generated and refined to provide reliable datasets to customers.

Hereinafter, an embodiment will be disclosed in which cyber threat information at a function unit included in an executable file can be very accurately identified and systematically obtained by using natural language models based on various AI agents from the executable file.

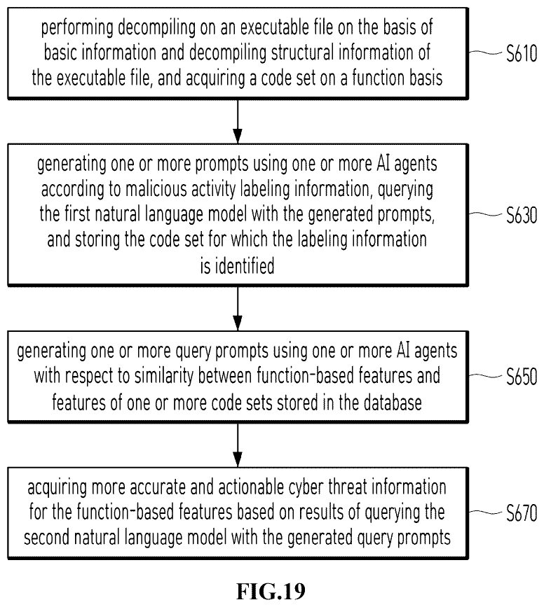

FIG. 19 discloses another embodiment for providing the cyber threat information according to the present disclosure.

An embodiment disclosed below can systematically separate functions included in an executable file into code sets that are easy for a human to analyze.

The disclosed embodiment may perform decompiling on an executable file on the basis of basic information and decompiling structural information of the executable file, and may thus obtain a code set on a function basis (S610).

A decompiler generally has low quality in converting an executable file, so that readable analysis and systematic management of analysis results are difficult. In order to overcome such problems, the embodiment may perform decompiling on the executable file on the basis of basic information such as metadata of the executable file and decompiling structural information and may obtain a readable code set on a function basis. Detailed embodiments and technical effects thereof will be described below.

In this manner, in order to obtain accurate and relevant cyber threat information for the code set on a function basis, the code set on basis of a function and labeling information for its cyber threat level may be stored in a database.

According to the embodiment, for a code set on a function basis, one or more prompts may be generated by using one or more AI agents according to malicious activity labeling information, and, as a result of querying the first natural language model with the generated prompts, the code set for which the labeling information is identified may be stored in the database (S630).

For systematic database construction, labeling information according to a cyber threat level corresponding to a function-unit code set may be generated. For functions in an input executable file, the accuracy of analysis can be improved not by one-off analysis, but by labeling information for cyber threat levels accumulated over time. Specific examples thereof will be described in detail below.

Meanwhile, in the embodiment, one or more query prompts may be generated by using one or more AI agents with respect to similarity between function-based features extracted from an input executable file and features of one or more code sets stored in the database (S650).

One or more AI agents may generate one or more query prompts with respect to similarity between features such as a feature vector or hash value of a function extracted from an input executable file and features of one or more code sets stored in the database as described above. By using such a process, the embodiment can enhance detection and identification of cyber threat information. Specific examples thereof will be described in detail below.

According to the embodiment, based on results of querying the second natural language model with the generated query prompts, more accurate and actionable cyber threat information may be acquired for the function-based features (S670).

Here, the second natural language model may or may not be the same natural language model as the first natural language model.

For the function-unit code set that may be included in an executable file as described above, a user can obtain more accurate cyber threat information through enhanced queries to an already constructed database. Specific embodiments thereof will be disclosed below.

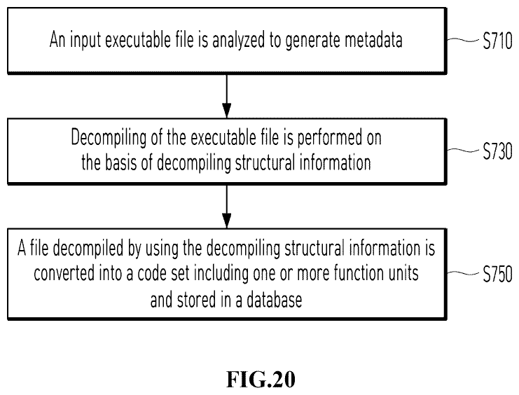

FIG. 20 discloses an example of obtaining a readable code set for a function from an executable file in the embodiments described above.

For example, executable files such as EXE, ELF, and DLL are written in binary machine code, and thus are difficult for a human to analyze directly.

When dynamic analysis, which analyzes behavior of an executable file in an execution environment of the file, is performed, it is difficult to analyze obfuscated code included in malware in the file, and it is hard to identify which code is activated through a specific input value or an execution flow of a function.

Similarly, in the case of static analysis that analyzes characteristics of an executable file, code is analyzed at an assembly language level, so that it is difficult for a human to understand and it is difficult to directly analyze a function or control flow. In addition, when an obfuscation technique is applied to malicious code, there is a problem in that analysis of the file becomes more difficult.

To analyze such binary code, it may be converted into assembly code by using a disassemble technique; however, since it consists of machine-language instructions, it is difficult for a human to analyze and verify it.

That is, assembly code obtained by converting binary code has low readability, and thus maintenance or development based thereon is not easy. However, when an executable file is converted, through decompiling, into a high-level programming language such as C or Python, readability is improved and development speed and maintenance can be facilitated on this basis.

In particular, an attacker who creates malware generally causes malicious behavior to be executed through a programming language rather than making the attack behavior be performed in an assembly language, and therefore it is more efficient to perform analysis by using decompiling.

In the disclosed embodiments, a binary file can be converted into code readable by a human by using a de-compiler.

However, if a binary file is simply decompiled, the converted code often has low quality, with many portions that are difficult for a human to read, and control flow in the code may be incorrectly analyzed or the result is difficult to utilize. According to the following embodiments, such drawbacks can be overcome.

The disclosed embodiments provide an example of obtaining a readable code set of an executable file, which can solve the above-described problems and enable detailed analysis of the executable file.

In the embodiments, an input executable file may be analyzed to generate metadata (S710). The executable file may be input by a user query, or an executable file input to the intelligence platform (CTI) may be delivered and used. The input file may be an executable file including EXE, ELF, or DLL.

The embodiments may analyze the input file to obtain basic metadata about the file and may analyze the metadata. For example, metadata about the file such as a creation date of the file, a type of the file, and a size of the file may be analyzed, and the analyzed metadata may be managed together with the executable file.

When the input file is packed, a packing type may be analyzed by using an unpacking analysis and then the file may be unpacked. When the file has been unpacked, information about the packing or unpacking may be included in the metadata.

An input and unpacked executable file is converted, by using a decompiler, into a code set that can be identified by a human, and the converted code set may be stored in a database together with the above metadata.

When the decompiler decompiles the file, it performs decompiling of the executable file on the basis of decompiling structural information (S730). Here, the decompiling structural information includes various execution conditions required to restore the internal code structure of the executable file, and by using this decompiling structural information, the internal code structure can be restored without directly executing the executable file

When the executable file is decompiled on the basis of the decompiling structural information according to the embodiments, the following operations can be performed.

Accordingly, when the executable file is decompiled on the basis of the decompiling structural information, a structure of internal code of the executable file can be understood without directly executing the executable file, and it can be converted into code sets that is easy for a human to understand, so that the code sets are easy to manage in a database.

The decompiling structural information according to the embodiments is information for restoring a structure of internal code of the executable file, and may include one or more pieces of information among search information of a program entry function included in the internal code, maximum depth (Max Depth) information of nested code according to a structure of the internal code, call relationship information for the functions, duplicate analysis removal information of the internal code, automatic string extraction information in the internal code, or post-processing execution information for readability of the decompiled code.

Therefore, when binary code of an executable file is decompiled on the basis of the decompiling structural information according to the embodiments, the internal code structure of the file can be restored without directly executing the executable file, strings in the code can be automatically extracted and restored, and code that is easy for a human to understand can be generated.

For example, input code may be decompiled by using decompiling structural information in which decompiling conditions are defined in a script or the like.

Here, when decompiling of a file is performed, the decompiling structural information may be defined so that functions such as an exit( ) function or an abort( ) function in the code of the file are recognized and excluded. In this case, by using the decompiling structural information, the function flow can be clearly analyzed.

If the decompiling structural information according to the embodiment is defined such that code that is not executed (unreachable code) is left as it is, it is possible to prevent a decompiling result from becoming incomplete.

Further, when decompiling of a file is performed, the decompiling structural information may be defined so as to activate constant propagation or to remove unnecessary constant calculations in the code, thereby simplifying complicated operations through removal of unnecessary code (simplifying double precision).

When decompiling of binary code is performed by using such decompiling structural information, automatic post-processing using regular expressions may be applied, whereby logical errors can be minimized and readability can be improved by preserving variable names and function names of the original binary as much as possible.

The decompiling structural information may be defined to automate analysis by analyzing a call graph of functions in a file. As described, when decompiling is performed, an entry function (main, entry, etc.) in the file may be automatically searched for, and an execution flow may be traced on the basis thereof.

When the decompiler decompiles an executable file with reference to the decompiling structural information, the decompiling structural information may analyze function call relationships in multiple stages and systematically organize a call structure between functions. Then, duplicate analysis can be prevented, thereby optimizing analysis speed. Through analysis of call relationships among functions, unnecessary external library calls can be filtered out so that only core code is extracted.

The decompiling structural information is defined to automatically extract or restore strings in a file. Then, the decompiler automatically restores ASCII and Unicode strings from memory on the basis of this structural information and converts them into a human-readable form. If a string is used in the code, it can be automatically analyzed and its association with a function can be traced.

As such, when the decompiler decompiles an executable file with reference to the decompiling structural information, the internal code structure can be restored without execution of the executable file, call relationships among functions can be organized, and string extraction and restoration can be performed according to the decompiling structural information, so that the code can be converted into a form that is easy for a human to understand.

In this manner, a file decompiled by using the decompiling structural information may be converted into a code set including one or more function units and stored in a database (S750). Alternatively, cyber threat information may be analyzed on the basis of the code sets of a function (hereinafter, function-unit code sets or function code sets).

As described above, when a decompiled file is converted into a code set and stored in the database, metadata of the corresponding file may also be stored together.

The decompiled executable file code may be made into a database (DB) and used for subsequent search and analysis. Then, the database can store code on a function basis, and information such as code for each function, an original address range, and function call relationships (call graph) can be stored in the database.

On the basis of this database, code sets included in an executable file can be searched and pattern analysis can be performed, and, for malware detection or code similarity analysis, a signature or code pattern of a specific function can be searched, and a code pattern including specific malicious behavior can be quickly searched in the database (DB).

In addition, on the basis of this database, changes in code can be tracked, and when a new binary file is input, a changed portion may be automatically detected by comparison with previously analyzed code, or a code change history may be managed to analyze differences resulting from a binary update.

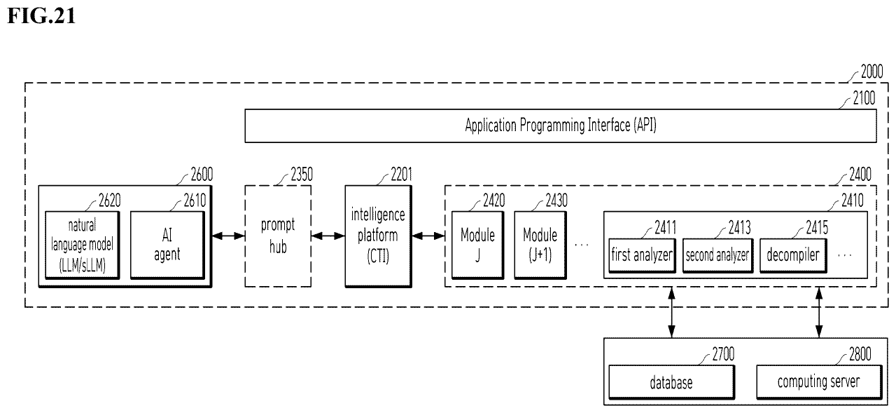

FIG. 21 discloses another example of an apparatus for processing cyber threat information.

The disclosed example of the apparatus for processing cyber threat information is similar to the example described above, but describes an example in which an executable file is decompiled and processed, focusing on a data processing unit 2400.

The embodiment may include a computing server 2800 including one or more processors that perform the disclosed steps on the basis of a database 2700, which is a storage device that stores data.

Here, an intelligence platform (CTI) 2201 receives various information, queries, and files requested by a user, processes the input data and cyber threat information, and provides the processed result to the user.

The intelligence platform (CTI) 2201 may include one or more modules for processing various pieces of information described above.

Above, the intelligence platform (CTI) 2201 disclosed an example of processing by disassembling an input file.

The embodiment disclosed here includes a data processing unit 2400 that decompiles an input file and stores it in a database.

The data processing unit 2400 may include a decompile module 2410 that decompiles an input file, and one or more modules such as Module J 2420, Module (J+1) 2430, and the like that respectively process various data.

In this example, the data processing unit 2400 may be included in a framework of the intelligence platform (CTI) 2201, but is illustrated separately from the intelligence platform (CTI) 2201 in order to distinguish the processing flow from the example in which the intelligence platform (CTI) 2201 disassembles an input file.

The data processing unit 2400 may be included as one module or sub-module of the framework of the intelligence platform (CTI) 2201, but, here, an example is illustrated on the premise that the data processing unit 2400 is separate from the intelligence platform (CTI) 2201.

The decompile module 2410 may include one or more analyzers 2411, 2413 that analyze an input file and a decompiler 2415.

When an input file is input from a user or the intelligence platform (CTI) 2201, the decompile module 2410 analyzes the input file to generate metadata and analyzes the metadata.

The input file may be an executable file including EXE, ELF, or DLL.

The decompile module 2410 may include a first analyzer 2411, a second analyzer 2413, and the decompiler 2415. The first analyzer 2411 of the decompile module 2410 may obtain metadata from the input file or obtain additionally analyzed metadata.

The second analyzer 2413, when the input file is a packed file, may unpack the file according to a type of packing through an unpacking analysis.

The decompiler 2415 of the decompile module 2410 may decompile the input file on the basis of decompiling structural information to obtain a code set in a readable programming language format.

The decompiling structural information may decompile the input file with various customized options.

As described, the decompiling structural information according to the embodiment is information for restoring internal code of an executable file, and may include one or more pieces of information among search information of a program entry function included in the internal code, maximum depth (Max Depth) information of nested code according to a structure of the internal code, call relationship information of the functions, duplicate analysis removal information of the internal code, automatic string extraction information in the internal code, or post-processing execution information for readability of the decompiled code.

According to various customized options, it is possible, without execution of the input file, to analyze a function flow and to convert, without decompiling code that is not executed, into code with readability for a human.

Depending on the options, information on function associations can also be obtained through function call relationship analysis due to function execution in the file, automatic extraction or restoration of strings, and the like.

The decompile module 2410 stores the obtained code set and the metadata analyzed as described above in the database. Accordingly, in this manner, information on a cyber threat level from an existing input file can be collected under predetermined conditions and accumulated in the database 2700.

For example, after decompiling, a code set in a format such as C programming code may be stored.

When an executable file is decompiled on the basis of decompiling structural information in order to obtain cyber threat behavior or information, analysis that enables reverse engineering can be performed. Attack patterns of functions that cause attack behavior can be identified on the basis of static analysis, and variants can be detected and handled through similarity analysis.

According to the embodiments, security vulnerabilities can be identified through function structure analysis, code including security vulnerabilities such as memory management problems of the file and user input processing errors can be searched, and it is advantageous to check security matters related to the code, such as whether a back door is executed.

Further, when decompiled code as described above is made into a database, automatic classification of files having similar code and functions becomes possible. In this way, based on the database created by collecting information from executable files, new malware can be detected through similarity determination, and furthermore, cyber attack behavior can be detected in advance and response strategies can be established. An APT (Advanced Persistent Threat) group can be tracked by analyzing whether an attacker reuses code.

An example of analyzing cyber threat information based on similarity of such database-structured decompiled code will be disclosed below.

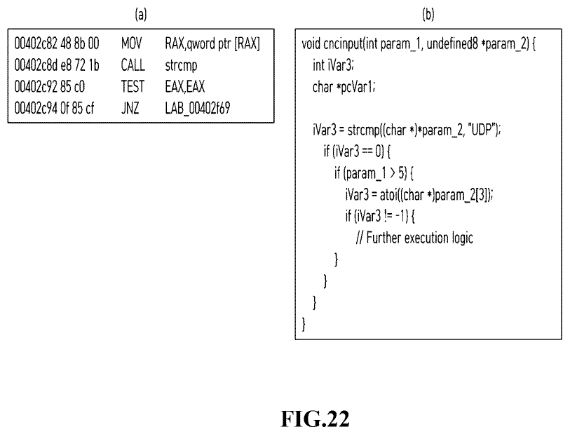

FIG. 22 illustrates code obtained by disassembling a file into assembly language and code obtained by decompiling the file.

In this figure, (a) is a result of disassembling an executable file into assembly language, and (b) illustrates code obtained by decompiling the same executable file.

In (a) of this figure, numbers and characters that are difficult for a human to understand are included, and therefore it is difficult to understand this, to identify cyber threat information, or to manage it.

However, in (b) of the figure, since the code sets are converted into a programming language, the role of each function can be understood. That is, as in (a) of the figure, it is difficult to understand the operation of instructions in assembly language, but when the executable file is decompiled on the basis of decompiling structural information, the execution structure of functions and variables can be restored into a programming language having readability, as in (b).

When labeling information related to a cyber threat level is attached to a function-unit code set on the basis of a decompiled file as in (b), cyber threat information can be analyzed in a more enhanced manner on a function basis.

According to the disclosed embodiment, even when malware in an executable file is obfuscated or it is difficult to grasp the execution flow of internal functions, cyber threat information can be efficiently analyzed by converting the executable file into a function-unit code set having high readability.

According to the embodiment, by using decompiling, variable names and function structures can be restored, and code that is easy for a human to understand can be analyzed.

When decompiling is used, by using code converted into a high-level language instead of assembly-based code, the logical flow in the code can be quickly grasped, so that analysis time can be reduced. Since malware is mainly written in high-level languages, by using the disclosed example, code written in such high-level languages can be restored into a form close to its original, and core functions can be quickly identified, thereby improving patch and response speed.

Hereinafter, an example of automatically classifying and verifying the function-unit code sets stored in the database as described above will be disclosed.

As described above, the process of analyzing the roles of functions included in a file and grasping the execution flow is very complicated, and thus is performed manually, whereby analysis time becomes long and accuracy deteriorates.

In order to identify how much each function contributes to execution of malware, when a security expert directly analyzes the functions, it is inefficient because it takes a lot of time, and unnecessary code is highly likely to be included when the validity of function code is evaluated. In addition, even for the same function, criteria for judgment may differ depending on the analyst, so that a problem arises in that the reliability of analysis results is lowered.

The following embodiment discloses an example of automatically classifying and verifying the function-unit code sets stored as described above.

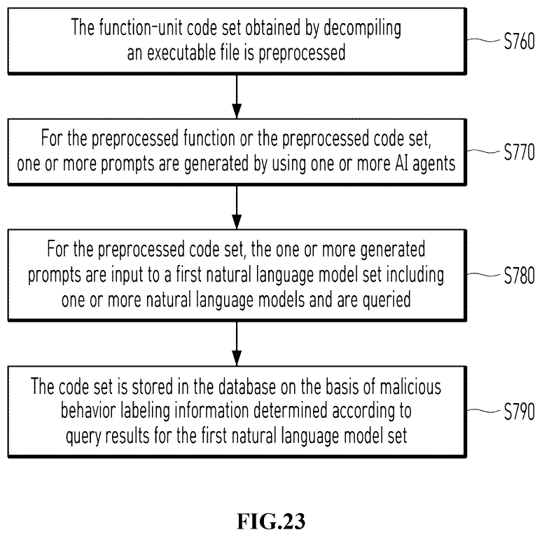

FIG. 23 discloses another embodiment for processing cyber threat information, namely an example of processing cyber threat information corresponding to one or more functions units.

Hereinafter, an example will be disclosed in which an AI agent is used to generate queries to a natural language model for the function-unit code sets stored in the database.

First, the function-unit code set obtained by decompiling an executable file are preprocessed (S760). As in the embodiment disclosed above, the decompiled function-unit code set is filtered, thereby leaving one or more core functions. For example, when it is decompiled into a C programming language format, comments or code lines and the like may be removed. Here, a core function means a function that plays a role in a cyber threat. The preprocessing of the code set will be described in detail in the embodiment below.

For the preprocessed function or the preprocessed code set, one or more prompts are generated by using one or more AI agents (S770).

Using the AI agents, a query prompt may be generated that requests generation of malicious behavior labeling information regarding a cyber threat level of the preprocessed function or code set.

For the preprocessed function or its code set, one or more prompts may be generated that query whether the function can cause malicious behavior in terms of a cyber threat level. That is, each prompt may be related to a cyber threat level of the function.

For example, depending on a cyber threat level or an intrinsic action of a function, different prompts can be generated, such as whether the preprocessed function is a general-purpose function unrelated to malicious behavior, a function related to malicious behavior, or a function related to a system call or a library.

When generating prompts, one or more AI agents may be utilized according to the cyber threat level or an intrinsic action of the function. And each AI agent may generate a prompt including malicious behavior labeling information according to the cyber threat level or its intrinsic action. Detailed examples thereof will be disclosed below.

For the preprocessed code set, the one or more generated prompts are input to a first natural language model set including one or more natural language models and are queried (S780).

After various prompts are generated according to malicious behavior labeling information, they can be queried to various natural language models. Then, for the input prompts, each natural language model may generate a natural language answer regarding the malicious behavior labeling information and the relevance to the code set, according to the principles and inference methods on which each model is based and according to the queries of the generated prompts.

Accordingly, a natural language answer can be obtained as to what importance the queried code set has with respect to malicious behavior. Detailed examples thereof will be disclosed below.

The code set is stored in the database on the basis of malicious behavior labeling information determined according to query results for the first natural language model set (S790).

According to results of querying one or more first natural language models about whether malicious behavior is present, using the one or more prompts generated by one or more AI agents as described above, when the malicious behavior labeling information of the natural language models matches or are the same, the malicious behavior labeling information may be determined according to the matched information.

If the malicious behavior labeling information of the natural language models does not match each another, the malicious behavior labeling information may be determined in consideration of the number of natural language models that provided matching results. Methods of handling unmatched malicious behavior labeling information, and examples in which priorities of labeling information for each prompt should be considered, will be disclosed in detail below.

The function or the code set for the function is stored in the database according to the malicious behavior labeling information determined as described above.

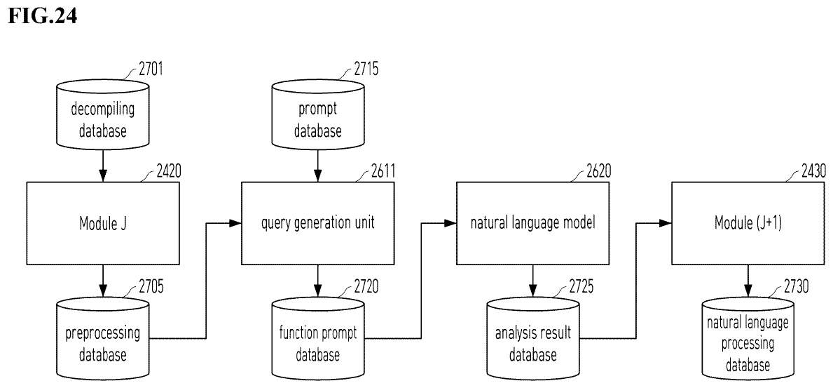

FIG. 24 illustrates another embodiment of processing cyber threat information.

Here, an example is disclosed in which, in order to determine the relevance of an executable file to cyber threat information, information as to whether a preprocessed function obtained from a decompiled file is related to a cyber threat is collected and stored in a database.

In the example described above, a code set for one or more readable function units obtained from a decompiled file is stored in a decompiling database 2701. Module J 2420 of a data processing unit 2400 may preprocess the stored code set from the decompiling data processing unit 2701 and store one or more code sets for a function (function-unit code sets) in the preprocessed code sets in a preprocessing database 2705. Here, preprocessing refers to a process of extracting one or more code sets for a function from a file and removing data that is unnecessary or unrelated to malicious behavior. Details of preprocessing of functions will be separately described below.

A query generation unit 2611 acquires the function-unit code sets stored in the preprocessing database 2705 and generates prompts to be queried to a natural language model set by using prompts stored in a prompt database 2715.

The query generation unit 2611 obtains, from the prompt database 2715, a system prompt for analysis of function-unit code sets. The query generation unit 2611 then causes one or more AI agents to generate different levels of malicious behavior labeling information according to cyber threat characteristics of the function-unit code sets.

Based on the system prompt, the query generation unit 2611 combines the preprocessed code sets with AI agents having different levels of labeling information, and generates function-analysis prompts that can query whether the combined code sets are related to malicious behavior.

The generated function-analysis prompts may be temporarily stored in a function prompt database 2720.

The query generation unit 2611 inputs the generated function-analysis prompts to a natural language model 2620, or inputs the prompts stored in the function prompt database 2720 to one or more natural language models 2620, thereby inputting to the one or more natural language models 2620 queries requesting analysis as to whether the code set is related to malicious behavior.

Then, the one or more natural language models 2620 or the natural language model set 2620 returns analysis results of malicious behavior for the queried code set, and the returned results may be temporarily stored in an analysis result database 2725. The analysis results may be stored or obtained in a desired file format, for example, a JSON format.

Module (J+1) 2430 of the data processing unit 2400 may, on the basis of query results for the function-unit code sets that are analyzed by the one or more natural language models 2620 or stored in the analysis result database 2725, determine whether the code set corresponds to an important function related to malicious behavior. Module (J+1) 2430 may store the selected function-unit code sets in a natural language processing database 2730.

Although the reliability of analysis results for a cyber threat level of the same function may vary depending on the analyst, the above processing makes it possible to objectively evaluate the cyber threat level of the function's role. When the natural language model includes a large language model (LLM) or a cyber-threat-specific language model, it is possible to more accurately and consistently determine labeling as to whether the function is a function that causes malicious behavior.

In the embodiment, for functions included in an executable file, it is possible, by using automated prompts, to obtain via queries to a natural language model whether a preprocessed function among previously analyzed function code sets is related to malicious behavior.

Hereinafter, the above-described embodiment will be divided into more detailed examples.

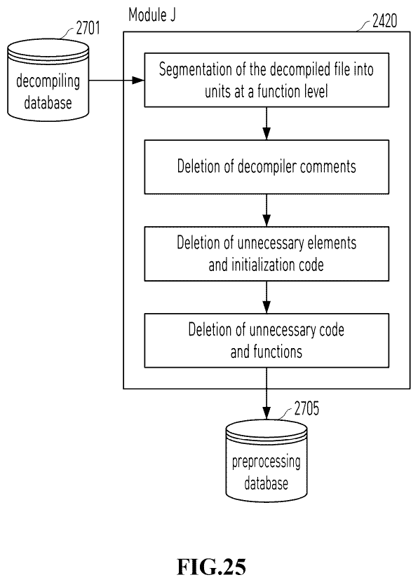

FIG. 25 illustrates an example of preprocessing function-unit code sets as an embodiment of processing cyber threat information.

Below, a preprocessing procedure is illustrated that removes inefficient data filtering and obtains consistent function-unit code sets. Here, Module J 2420 may perform preprocessing of functions.

Module J 2420 obtains a decompiled file stored in the decompiling database 2701 and may extract, from the decompiled file, only functions that are meaningful in terms of cyber threats.

For example, in one example, Module J 2420 may segment the decompiled file into units at a function level.

In addition, in one example, Module J 2420 may delete unnecessary strings or comments. For example, comments such as “//”, “/*/”, or “https://” in the code of a file may be removed so that noise does not occur during the analysis process.

In one example, Module J 2420 may replace escape strings with code that is functionally meaningless while preserving the original code.

In one example, Module J 2420 may delete unnecessary code lines from the decompiled file, such as simple variable declarations, initialization code and so on. For example, memory-initialization code (such as “=”, ‘\0’;) in the code may be removed, leaving in the decompiled file only functions that may play a role in cyber threats, while filtering out the rest.

In one example, Module J 2420 may delete functions if their length in the decompiled file is below a certain threshold, for instance, 80 or less. This can reduce the time required to analyze functions extracted from the decompiled file.

In addition, when there is a corrupted function for which decompiling has failed (for example, “halt_baddata( )”), Module J 2420 may automatically filter out and delete the function.

In this example, Module J 2420 may store, in the preprocessing database 2705, function-unit code sets that can play a role in cyber threats after filtering.

As described above, Module J 2420 can extract functions related to malicious behavior from the decompiled file and remove unnecessary elements.

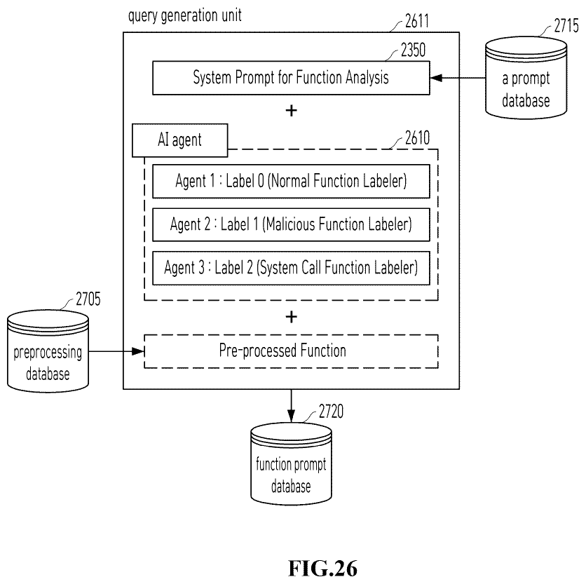

FIG. 26 illustrates an embodiment of processing cyber threat information, and in particular, an example of generating queries for function-unit code sets.

This is an example of generating queries that can be submitted to a natural language model by assigning labeling according to cyber threat levels to function-unit code sets

A query generation unit 2611 may use a prompt hub 2350, an AI agent 2610 including one or more agents, or both the prompt hub 2350 providing system prompts and the AI agent 2610.

Here, for convenience of explanation, an example is described in which both the prompt hub 2350 and the AI agent 2610 are used to generate queries. In this example, the query generation unit 2611 is a data processing unit that includes both the functions of the prompt hub 2350 and the AI agent 2610.

A prompt hub 2350 included in the query generation unit 2611 may obtain prompts from a prompt database 2715 and generate system prompts for function analysis. The prompt hub 2350 may be configured to return an empty file when there is no target function-unit code set.

The query generation unit 2611 may cause one or more agents included in the AI agent 2610 to generate query prompts based on labeling information classified according to cyber threat levels.

In this example, the AI agent 2610 may include three agents, each generating query prompts based on different labeling information corresponding to different cyber threat levels.

For example, when the analysis result of a function-unit code set obtained from a preprocessing database 2705 is “normal”, the AI agent 2610 may cause Agent 0 to generate a prompt in which labeling information (Label 0) indicating a normal function is combined with the function-unit code set.

When the analysis result of the function-unit code set is a malicious function, the AI agent 2610 may cause Agent 1 to generate a prompt in which labeling information (Label 1) indicating a malicious function is combined.

When the analysis result of the function-unit code set is related to a system call, the AI agent 2610 may cause Agent 2 to generate a prompt in which labeling information (Label 2) indicating a system call function is combined.

The AI agent 2610 stores the generated prompts in a function prompt database 2720.

In this manner, prompt generation can be automated so that a natural language model can analyze preprocessed function-unit code sets using the prompts generated by the AI agent 2610.

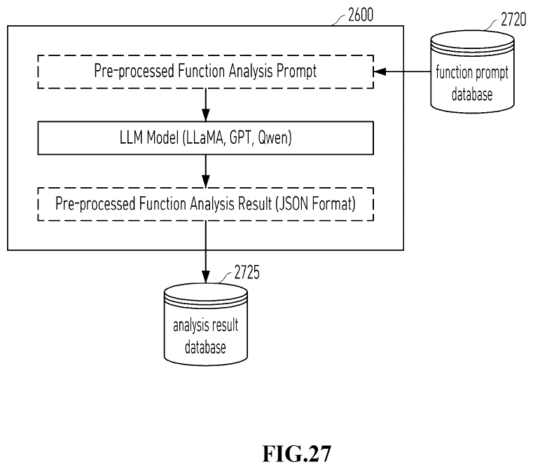

FIG. 27 illustrates, as an embodiment of processing cyber threat information, an example of obtaining query results for function-unit code sets.

Hereinafter, an example is described in which the prompts generated in the above embodiment are input to one or more natural language models to obtain information such as whether the corresponding function is related to cyber threat behavior or whether it is a function that triggers malicious behavior.

An answer generation unit 2600 may query one or more natural language models 2620 regarding the relevance of a preprocessed function-unit code set to cyber threat behavior, using function prompts generated by the query generation unit 2611 or function prompts stored in the function prompt database 2720.

When a plurality of natural language models 2620 are provided, cross-validation can be performed using multiple models. The natural language models 2620 may be open-source models or general-purpose models, or may be proprietary models or specialized vertical AI models.

In the example of this figure, GPT, LLAMA, and Qwen are illustratively mentioned as natural language models; however, the type of natural language model is not limited in the spirit of the present embodiments.

The natural language models 2620 may provide information as to whether the function-unit code set associated with the input query prompt is involved in a cyber threat.

Analysis results for cyber threat information regarding the function-unit code sets, received by the answer generation unit 2600 from the natural language models 2620, may be stored in an analysis result database 2725.

The analysis results for cyber threat information on the code set may include labeling information attached to the code set, the name of the function corresponding to the code set, and reasons why the code set is related to cyber threat information.

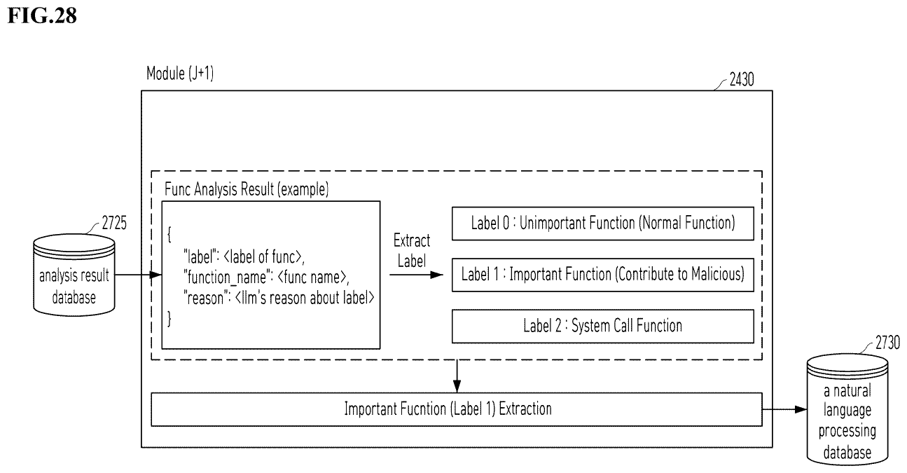

FIG. 28 illustrates, as an embodiment of processing cyber threat information, an example of processing natural language processing results.

Module (J+1) 2430 of the data processing unit 2400 may select, from a cyber-threat perspective, important functions based on analysis results regarding the relevance between function-unit code sets and cyber threats, the analysis results having been produced by one or more natural language models 2620.

Module (J+1) 2430 may receive analysis results for function-unit code sets stored in an analysis result database 2725 and may obtain labeling information corresponding to the results.

When the labeling information in the analysis results of a function, as answered by the one or more natural language models 2620, are mutually consistent, Module (J+1) 2430 may determine the label of the function, or of the corresponding function-unit code set, according to the consistent labeling information.

If the analysis results of the function provided by the one or more natural language models 2620 are not consistent with one another, Module (J+1) 2430 may count the number of occurrences of each label and determine whether the corresponding code set is malicious based on the counted occurrences.

As another example, the cyber-threat level of a function may be determined by prioritizing a Label 1 (function related to malicious behavior). If no Label 1 is present, labeling information may be assigned to the code set corresponding to the function by applying priorities in the order of Label 2 (system call function) and then Label 0 (normal function).

Module (J+1) 2430 may store, in a natural language processing database 2730, result data obtained by assigning labeling information to function-unit code sets and selecting functions as described above.

Accordingly, in the disclosed embodiment, automated analysis of executable malicious files is made possible. By using natural language models, manual work in the malicious file analysis process can be minimized, fast and consistent results can be provided, and it is easy to identify which functions within a file are related to malicious behavior.

In the embodiment, unnecessary code in a file can be removed to improve analysis accuracy, and using one or more natural language models enables cross-validation of results, thereby enhancing reliability.

Furthermore, even for files containing new types of malicious code, the code can be continuously collected, analyzed, and stored in the database, thereby improving overall performance over time.

According to the disclosed embodiment, even when the execution flow of functions within a file is complex, when it is difficult to identify how much each function contributes to malicious code, or when the criteria for judging the degree of contribution to malicious behavior depend on the skill of an analyst, analysis results can still be improved by an automated and reliable process.

The disclosed embodiment enables precise identification and extraction of key functions related to malicious behavior based on multiple agents. Automated analysis provides fast and consistent analysis results, and unlike conventional assembly-level filtering, unnecessary code can be precisely removed, significantly improving analysis accuracy.

In addition, analysis based on multiple natural language models increases the reliability of the analysis, and by applying adaptive function labeling, consistent analysis performance can be maintained even for newly emerging malicious code.

Using the reliable information collected as described above, embodiments for identifying cyber threat behaviors will now be described.

After decompiling the executable file and performing preprocessing to improve efficiency as described above, a process is disclosed in which cyber threat identification results are further enhanced based on a database in which reliable cyber threat information has been collected via natural language models.

Multiple code sets whose cyber threat levels have been determined based on natural language processing results may be compared with code sets already stored in a database to determine their similarity.

However, in such a processing flow, conventional code comparison methods either perform text-based comparison (diff-type comparison) or perform comparison after converting code into an abstract syntax tree (AST). A text-based comparison method (diff method) has difficulty detecting simple code changes when obfuscated code is included or variable names are changed in the code.

In an AST-based comparison method, a large amount of time is required to compare tree structures, and it is difficult to detect complex code transformations.

In another example, machine-code (assembly)-based analysis is difficult for humans to understand and suffers from slow analysis speed even after decompilation. Moreover, when similarity is determined only by hashing values such as MD5 or SHA, even a slight change in the code produces a completely different hash value.

That is, in conventional methods, when obfuscation or code transformation occurs, even identical code is likely to be recognized as different code, which makes it difficult to rapidly obtain similarity between function-unit code sets.

Hereinafter, an embodiment will be described that can provide more reliable results than conventional code comparison methods, enables fast similar-code search, and achieves both accuracy and efficiency in comparison analysis results.

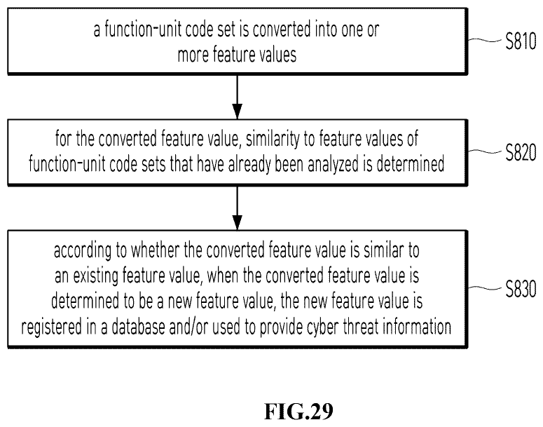

FIG. 29 illustrates another embodiment of a method for processing cyber threat information.

First, a function-unit code set is converted into one or more feature values (S810).

In the embodiments described above, the function-unit code set may be a code set determined, based on natural language processing results, to be related to a cyber threat, or may be a code set extracted on a function basis from a decompiled executable file.

For example, in C-language code obtained through decompilation, a function-unit code set may be extracted on the basis of a function signature (declaration) and curly braces { }. Alternatively, a function-unit code set may be extracted after removing unnecessary declarations inside a function and performing normalization on the function body.

In this example, an embodiment is described in which feature values for function-unit code sets related to cyber threats are rapidly generated based on natural language processing results.

A function-unit code set to which labeling for a cyber-threat level has been attached according to natural language processing results may be converted into a feature vector, and such conversion can be effectively performed by using a deep-learning-based embedding model. The embedding model may learn contextual information of the code set and convert it into a feature vector, and the feature vector may in turn be converted into one or more feature values such as a hash value.

By converting the function-unit code set into a feature vector or hash value based on a deep-learning-based embedding model, comparison of code can be facilitated.

Any of various schemes may be used to convert a feature vector into a hash value. Hereinafter, with various embodiments, an embodiment is described in which locality-sensitive hashing (LSH)-based hash conversion is used to perform fast similar-code search.

For the converted feature value, similarity to feature values of function-unit code sets that have already been analyzed is determined (S820).

Based on the converted feature value, cyber threat information, such as an attack or malicious behavior associated with the function-unit code set, can be determined.

If the converted feature value is judged to fall within the same range as an existing analyzed value, the existing analyzed cyber threat information may be adopted. If the converted feature value is new, it may be determined whether the new value falls within a similarity range of the previously analyzed values. Detailed examples of this will be described below.

According to whether the converted feature value is similar to an existing feature value, when the converted feature value is determined to be a new feature value, the new feature value is registered in a database and/or used to provide cyber threat information (S830).

If the converted feature value is a new value that is not similar to existing analyzed values, the function-unit feature value may be registered and stored in the database as new cyber threat information.

This can be utilized as a basis for analyzing or providing cyber threat information.

By systematically storing embedding-based converted representations of function-unit code sets and their hash-value conversions, analysis efficiency can be maximized.

Hereinafter, detailed embodiments of processing cyber threat information based on function-unit code sets that have been assigned cyber-threat-level labels according to natural language processing results will be described.

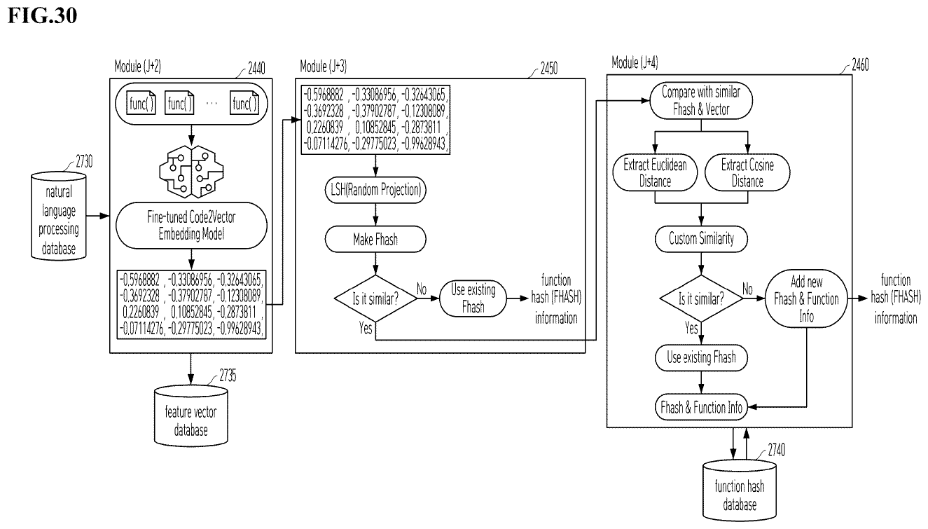

FIG. 30 illustrates another exemplary embodiment of a cyber threat device for processing cyber threat information.

A data processing unit 2400 of the cyber threat device described above may include one or more modules capable of converting a function-unit code set, which has labeling of a cyber threat level identified according to a natural language processing result, into a feature value by which cyber threat information can be determined.

This embodiment exemplifies such modules as, respectively, Module (J+2) 2440, Module (J+3) 2450, and Module (J+4) 2460.

In the above embodiment, the function-unit code set is stored in a natural language processing database 2730 together with labeling information whose cyber threat level is determined after querying natural language models.

Module (J+2) 2440 retrieves the function-unit code set stored in the natural language processing database 2730 and converts it into a feature vector. The function-unit code set stored in the natural language processing database 2730 may additionally have labeling information of a cyber threat level according to a natural language processing result.

In this embodiment, Module (J+2) 2440 may convert the function-unit code set into a feature vector representing characteristics of the code set by using an embedding model of Module (J+2) 2440. Module (J+2) 2440 may store the converted feature vector in a feature vector database 2735.

The process in which Module (J+2) 2440 converts the function-unit code set into the feature vector by using the embedding model (embedding model) will be described by way of example as follows.

Module (J+2) 2440 may tokenize (tokenizer) the function-unit code set, which is input data.

Module (J+2) 2440 prepares input data by segmenting the input code set into predetermined units so as to tokenize the input code set.

Then, Module (J+2) 2440 may convert tokens, which are obtained by dividing the input data into predetermined units and include a mask capable of distinguishing between the input data and a padding portion, into hidden states of input layers of an artificial intelligence algorithm, and may encode them in the form of a dictionary.

Using the hidden states of a last layer, a mask for each token position is multiplied by the hidden states, and then a fixed-length vector serving as an embedding of the input data may be output by a max-pooling (Max-pooling) method.

The fixed-length vectors thus obtained may be used for classification, retrieval, and clustering of cyber threat information thereafter.

The fixed-length vectors obtained by converting the function-unit code sets may be stored in the natural language processing database 2730 or delivered to Module (J+3) 2450. In this case, the vector converted by the embedding model may be stored together with, for example, a name of a file including this function vector, a name of a function, and the like.

Module (J+3) 2450 may obtain a function-unit feature vector stored in the feature vector database 2735 or a function-unit feature vector according to a processing result of Module (J+2) 2440.

Module (J+3) 2450 may convert the function-unit feature vector into a function-unit hash value. According to the embodiment, Module (J+3) 2450 exemplifies converting the function-unit feature vector into the function-unit hash value according to LSH (Locality Sensitive Hashing) based on a random projection (Random Projection) method.

The random projection (Random Projection) method is a data conversion method that reduces a dimension of high-dimensional data while maximally preserving distances between data.

A random projection method based on orthogonal_random_planes may be configured to be very fast and to be capable of preserving a structure or similarity of data.

An LSH (Locality Sensitive Hashing) hash value is a method of rapidly converting high-dimensional data into similar hash values such that data located at neighboring positions have the same hash value with high probability.

However, this is merely one example of converting the function-unit feature vector into the hash value, and various types of algorithms, such as a t-SNE (t-distributed Stochastic Neighbor Embedding) method, a UMAP (Uniform Manifold Approximation and Projection) method, a Product Quantization (PQ) method, or a Min-Hash method, may be used in consideration of a data distribution. In addition, although described above as having problems, a PCA (Principal Component Analysis) method exemplified above, which reduces dimensions in an optimal direction, may also be used.

When Module (J+3) 2450 generates a hash value for the function-unit feature vector (indicated as “Make Fhash” in the figure), whether this value is a new value is determined (indicated as “is it new?” in the figure), and if it is an existing hash value (indicated as “No” in the drawing), a previously analyzed function and hash value may be used (indicated as “using existing Fhash” in the figure).

If it is a new hash value (indicated as “Yes” in the drawing), it is delivered to Module (J+4) 2460 in order to determine similarity with a previously analyzed hash value.

Module (J+4) 2460 may, on the basis of the hash value for the function-unit code set converted by Module (J+3) 2450, that is, the function-unit hash value, search in a function hash database 2740 for whether there is a similar function hash value.

In this example, Module (J+4) 2460 may search for whether there is a previously analyzed hash value on the basis of similarity according to one or more similarity comparison methods (indicated as “is it similar?” in the fugure) for the function-unit hash value.

If there is a similar hash value in the function hash database 2740 (indicated as “is it similar? Yes” in the figure), an existing function-unit hash value and existing function information are used, and if it is a new hash value (indicated as “is it similar? No” in the figure), it may be stored in the function hash database 2740 as a new function-unit hash value and new function information (indicated as “Add new Fhash & Function info” in the figure). Then, it may be used as a new input data value and used to process cyber threat information.

In this embodiment, one or more similarity comparison methods may be used to compare the function-unit hash values (indicated as “compare with similar Fhash & Vector” in the figure), and, for example, various vector similarity methods may be applied together in order to compare hash values.

A similarity based on Euclidean Distance and a similarity based on Cosine Similarity may be combined so as to evaluate similarity by taking into account both magnitudes and directions between two vectors.

The similarity based on Euclidean Distance may be expressed by the following Equation 1.

$$d ( a , b ) = \sqrt{{\sum }_{i = 1}^{n} {( {a}_{i} - {b}_{i} )}^{2}} \qquad [ Equation 1 ]$$

A similarity based on Euclidean Distance measures an absolute distance difference between two vectors a and b.

A similarity based on Euclidean Distance reflects a difference in magnitude of vectors, but does not take directionality into account, and therefore has a weakness in that vectors having similar patterns may be evaluated as being far apart from each other even when their magnitudes are different.

Meanwhile, Cosine Similarity may be expressed by the following Equation 2.

$$cos ( θ ) = \frac{a \cdot b}{‖ a ‖ ‖ b ‖} \qquad [ Equation 2 ]$$

Cosine Similarity is a method of evaluating similarity in direction by measuring an angle between two vectors. Cosine Similarity considers only direction irrespective of magnitudes of vectors, and thus has a disadvantage in that even vectors having small magnitudes show high similarity when they have the same directionality.

As described above, there are various methods for evaluating similarities of vectors, and each method has advantages and disadvantages. Accordingly, herein, in order to overcome such limitations, a similarity of feature vectors or feature hash values may be determined by combining various similarity methods.

Herein, a method of determining similarity between two vectors by combining two or more similarity methods is referred to as a Custom Similarity method.

For example, a Custom Similarity obtained by combining the similarity based on Euclidean Distance and Cosine Similarity as exemplified above may be represented by Equation 3 as follows.

$$Mixed Similarity ( A , B ) = \frac{Cosine Similarity ( A , B )}{Euclidean Distance ( A , B ) + ϵ} \qquad [ Equation 3 ]$$

This embodiment represents a ratio of Cosine Similarity to Euclidean Distance, and by combining Euclidean Distance and Cosine Similarity, it is possible to more accurately measure similarity between a feature vector and a previously analyzed feature vector.

Here, “E” (epsilon) is a variable for combining and adjusting the two similarities and generally takes a very small value.

For example, similarity may be determined by setting a specific similarity criterion, such as Cosine Similarity of 0.998 or higher, or Euclidean Distance of 0.99 or lower.

In this manner, similarity of a feature vector or hash value corresponding to a function-unit code set may be determined by combining two or more similarity methods, and for example, Euclidean Distance reflects a difference in magnitude, and Cosine Similarity reflects similarity in direction, thereby enabling accurate determination of similarity.

As in the disclosed embodiment, by using two or more algorithms for determining vector similarity, similarity between a feature vector of an input code set and a previously stored feature vector may be obtained, and cyber threat information may be obtained by using the similarity.

Meanwhile, in the above embodiment, an example has been disclosed in which a function vector is converted into a representative vector by using an embedding model and then converted into a function hash value for use.

It is preferable that the feature vector and hash value disclosed in this figure apply an LSH (Locality Sensitive Hashing) method. When using LSH (Locality Sensitive Hashing) to convert into feature vectors and hash values, there is a difference, in terms of embodiments and technical effects, from converting a representative vector into a hash value by a PCA (Principal Component Analysis) method disclosed above.

For example, when the LSH (Locality Sensitive Hashing) method is applied, a method of hashing high-dimensional data using a random hyper-plane (Random hyper-plane) is used, and therefore a specific characteristic of a function can be preserved while enabling rapid search. That is, when a new function is input, a function-unit hash value can be generated without needing to retrain an existing model, and thus a hash value of a specific function does not change and a consistent hash value can be maintained.

In addition, the LSH (Locality Sensitive Hashing) method can reflect a nonlinear structure, thereby more effectively reflecting complex relationships of functions while reducing computational load.

That is, in the PCA method, existing data must be retrained whenever a new function is identified, whereas in the LSH (Locality Sensitive Hashing) method, additional training is not required, and thus rapid response is possible when a new malicious code pattern or a function that causes it appears.

Further, in the PCA method, specific functions may have the same hash value, whereas in the LSH (Locality Sensitive Hashing) method, random hyper-planes are sampled on the basis of a normal distribution and orthogonality is enforced so that a hash space can be designed to be more uniformly distributed, thereby alleviating a space imbalance problem while maintaining retrieval efficiency.

According to the disclosed embodiment, code analysis can be automated, malicious code can be detected to analyze vulnerabilities, and code changes can be tracked. In addition, automated code analysis results can be utilized in a field of reverse engineering analysis.

According to the disclosed embodiment, even when comparing similarity of function-unit code sets within obfuscated or modified code, reliable results can be obtained, rapid similar code search is possible, and efficiency can be obtained along with accuracy of comparative analysis results.

In conventional methods, an embedding model had to be retrained for each new data set, but according to the disclosed embodiment, by utilizing a foundation model based on a high-level programming language, embedding vectors for new data can be generated without retraining. That is, flexible real-time response is possible in an ever-changing cyber security environment.

According to the disclosed embodiment, by generating an LSH-based hash, a complex function structure and nonlinear structure can be reflected, and an advanced logical structure of malicious code can be more effectively reflected. An LSH-based hash technique can generate uniformly distributed hash values in a hash space through normal-distribution-based sampling and enforcement of orthogonality, thereby improving retrieval efficiency.

Hereinafter, an example will be disclosed in which a report is automatically generated for an event related to cyber threat information by comparing functions included in an input file.

As disclosed, similarity matching based on conventional hashing techniques has had limitations in identifying variants of malicious code.

Based on such techniques, cyber threat reports have not only been inaccurate, but have also required a researcher to directly perform code comparison and analysis, thereby consuming much time and cost. In addition, in the case of manual analysis, criteria of judgment may vary depending on analysts, which has caused a problem that reliability of results is low.

Hereinafter, an embodiment capable of solving such conventional problems on the basis of the embodiment disclosed above will be described.

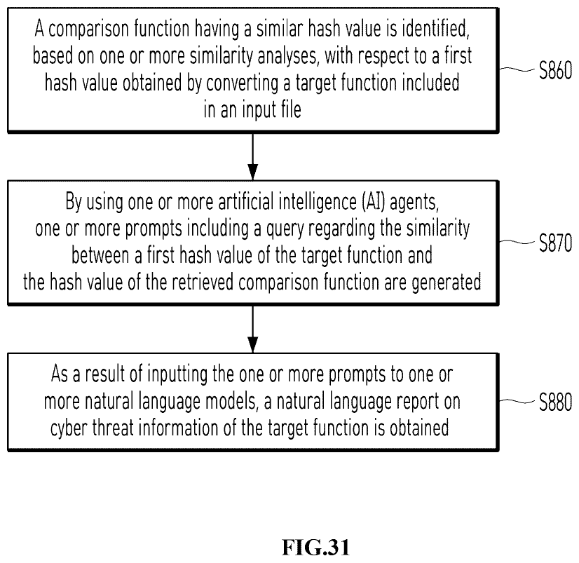

FIG. 31 illustrates an embodiment of a method for processing cyber threat information.

A comparison function having a similar hash value is identified, based on one or more similarity analyses, with respect to a first hash value obtained by converting a target function included in an input file (S860).

In an embodiment, an executable file may be input from a user or an intelligence platform (CTI). The examples of obtaining a function-unit code set by preprocessing functions included in decompilation of the executable file have been disclosed above.

A code set of a target function included in a decompiled function is converted into a first hash value. The embodiments of converting a function-unit code set into a feature vector and/or a hash value have also been disclosed above.

The examples of constructing a database in which hash values of functions are analyzed and stored have been disclosed above. On this basis, a similar hash value may be searched to identify a comparison function, or a comparison function having the hash value may be found.

Based on the first hash value of the converted target function, a similar hash value is retrieved from an already stored database on the basis of one or more similarity analyses. As exemplified above, a similarity of hash values may be determined by using a custom similarity that combines two or more similarity analysis methods, and one or more similar hash values may be obtained.

When a comparison function having a similar hash value is registered in the database, a comparison function similar to the target function can be identified.

By using one or more artificial intelligence (AI) agents, one or more prompts including a query regarding the similarity between a first hash value of the target function and the hash value of the retrieved comparison function are generated (S870).

Based on a hash value similar to a first hash value of the target function searched above, one or more prompts including a query as to whether the target function and the comparison function are similar may be generated.

First, on the basis of a system prompt for causing similarity between the target function and the comparison function to be analyzed, one or more AI agents may be caused to generate query prompts regarding similarity in terms of cyber threats for one or more AI agents.

Queries regarding similarity of functions in terms of cyber threats may include a query for causing differences in code sets between the target function and the comparison function, an analysis of a functional change of the target function, an analysis of an impact of the target function on a cyber threat, and/or a summary-generation query for causing a query thereon to be described in natural language.

That is, one or more queries including a system prompt, one or more AI agents that generate a query for function-difference analysis, and the target function and the comparison function may be generated. It may also be generated as a prompt bundle including a plurality of queries.

As a result of inputting the one or more prompts to one or more natural language models, a natural language report on cyber threat information of the target function is obtained (S880).

When the one or more input prompts analyze results of the target function and the comparison function according to the queries, a cyber threat information report may be generated. In such a cyber threat information report, answers according to the queries are described in natural language, thereby providing a rapid and automated report to a user, and accurate and consistent information can be provided on the basis of an inference and an evidence database on which the natural language model is based, without relying on an analyst's experience.

A comparison result of the two functions, or new information on a cyber threat of the target function and a generated report may be stored in a database and used to determine cyber threat information of another function. Such a report may be provided to the user including a unique report identifier indicating proof of origin, such as a watermark.

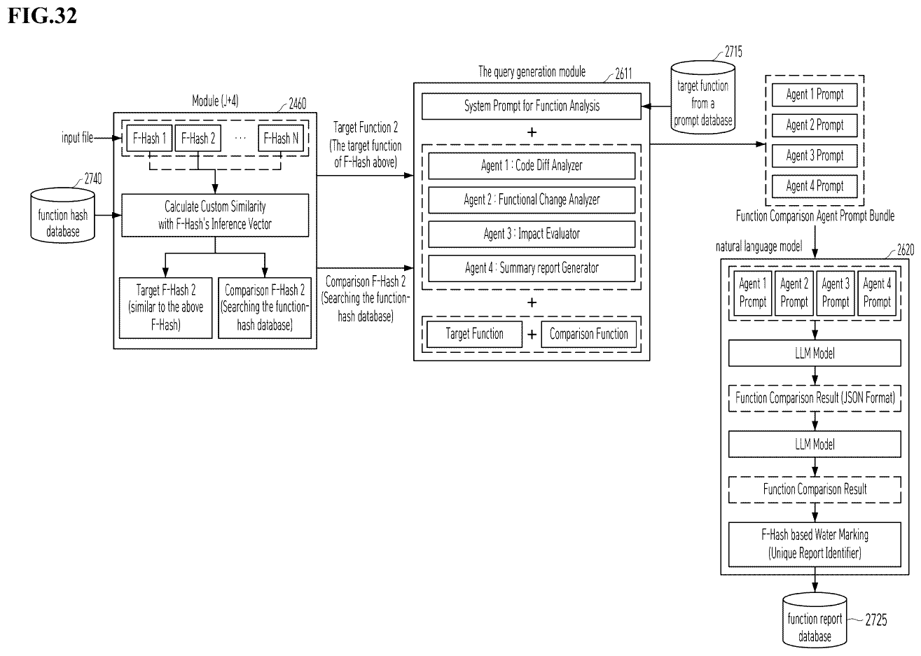

FIG. 32 illustrates another embodiment of a cyber threat device that implements the disclosed embodiment of cyber threat processing.

Here, several modules included in the data processing unit 2400 among the embodiments disclosed above are illustrated and described.

This embodiment can efficiently analyze functions or code functionalities and changes included in an executable file and automatically provide a user with consistent reports on cyber threat information and its impact.

Module (J+4) 2460 of the data processing unit 2400 may receive function-unit hash values included in an executable file as input. In this figure, such function-unit hash values are denoted as F-Hash 1, F-Hash 2, . . . , and F-Hash N.

Among these, in order to obtain cyber threat information related to a hash value F-Hash 2 based on a specific target function, a hash value of a comparison function similar to the target function may be searched from a function hash database 2740 that has been previously analyzed and stored.

When a similar function hash value is retrieved from the function hash database 2740, as in the example disclosed above, Module (J+4) 2460 may search for a hash value (Comparison F-Hash2) of a comparison function similar to a hash value (Target F-Hash 2) of the target function, based on a custom similarity method that combines a plurality of similarity analyses. Examples of the custom similarity analysis have been described in detail above.

The hash value (Comparison F-Hash2) of the comparison function and the hash value (Target F-Hash 2) of the target function retrieved by Module (J+4) 2460 may be delivered to the query generation unit 2611.

The query generation module 2611 may obtain a system prompt for analysis of the hash value of the target function from a prompt database 2715.

The query generation module 2611 causes one or more AI agents to generate queries related to similarity, in terms of cyber threats, between the target function hash value and the comparison function hash value.

Here, queries related to similarity in terms of cyber threats include a query on a code set of the target function and a code set of the comparison function, a query on analysis of functional differences or changed functionalities between the target function and the comparison function, a query on impact analysis in terms of cyber threats, and a request for generation of a summarized report including answers to the above queries.

Queries generated according to similarity in terms of cyber threats may include information on how the code set of the target function and the code set of the comparison function differ. In addition, the generated queries may include information on what functions and differences the target function and the comparison function have in terms of cyber threats.

The generated queries may include analysis information on how the two functions contribute to a threat in terms of cyber threats or by what mechanism they operate.

Then, AI agents of the query generation module 2611 may generate related query prompts according to the requested information.

The query generation module 2611 may output a set of query prompts or a query prompt bundle generated by AI agents that generate queries related to similarity in different cyber threat perspectives, based on the system prompt, for the target function hash value and the comparison function hash value.

In this figure, the set of query prompts or the query prompt bundle generated by the AI agents is denoted as Agent 1 Prompt, Agent 2 Prompt, Agent 3 Prompt, and Agent 4 Prompt.

The natural language model 2620 may generate answers to the queries and provide them to a user as a report including cyber threat information based on natural language.

The natural language model 2620 receives the set of query prompts or the query prompt bundle generated by the AI agents and analyzes the target function and the comparison function. Then, a file of a predetermined format, for example, an analysis report in a JSON format or a PDF format, may be generated for the analysis result. A report including cyber threat information may include a unique report identifier for proof of origin.

When an external natural language model 2620 is used, a separate answer generation unit of the data processing unit 2400 may receive a function analysis result from the natural language model 2620 and provide a report on cyber threat information.

For example, a cyber threat information report may include an identifier of the report and may include a unique watermark or the like for authentication of an organization or method that generated the report. In this way, reliability of an analysis result and origin of the cyber threat information report can be granted.

The generated report may be stored in a function report database 2725 and used for later review and re-analysis, and may also be used as legal evidence material related to cyber threats.

As in the embodiments, functions included in an executable file can be precisely analyzed by using multiple AI agents, and differences in code that were previously reviewed directly by a researcher can be examined rapidly and accurately.

In addition, for the target function in the file and an already analyzed comparison function, differences in code sets (Code Diff), changes in functionality (Functional Change), and cyber threat impacts may be automatically generated as a natural language report, so that not only simple code changes but also vulnerabilities or changes in cyber threats caused by subtle differences can be detected.

According to the embodiment, consistency of analysis results according to an automated function comparison process can be increased, and a user can rapidly obtain the analysis results.

Since the target function and the already analyzed comparison function are compared based on the natural language model, consistent analysis results can be obtained, and it is possible to analyze how changes in the functionality of the target function affect an operation manner of malicious code.

For example, when a network calling method is changed, it can be automatically evaluated whether it is a simple code modification or an attack method using a new C2 server.

The natural language report may have information on which function in the file is comparatively analyzed, for example, in a form such as <Target F-Hash>-<Analyzed Date>-<Comparison F-Hash>, and may include watermarking as a unique report identifier.

According to the disclosed embodiment, even when it is difficult to identify variants by analyzing function similarity based on a conventional hashing technique, similarity analysis of functions can be efficiently performed, and a cyber threat information report including reliable results can be automatically generated.

According to the disclosed embodiment, it is possible not merely to determine simple code changes of malicious code, but to determine impacts on cyber threats according to code changes by using multiple agents.

According to the disclosed embodiment, automated function comparison and analysis can be performed so that an analysis time that takes from several hours to several days can be reduced to several minutes to provide results. In addition, since different results and criteria by analysts are not applied, consistent and in-depth results are provided in natural language, thereby improving reliability of cyber security analysis.

Hereinafter, an example capable of providing analysis information on cyber threat information by using the embodiments disclosed above will be described.

As described above, when a security manager manually analyzes function units of a malicious file, a large amount of time and manpower is consumed, and there is a limitation in quickly processing analysis of a large number of files. Even in the case of an expert, when the functionalities and roles of functions in a file are manually analyzed, there is a problem in that analysis results differ depending on the expert's level of skill or experience.

Hereinafter, an example is disclosed that solves these problems and automatically processes a large number of files to provide analysis results of cyber threat information in a consistent and rapid manner.

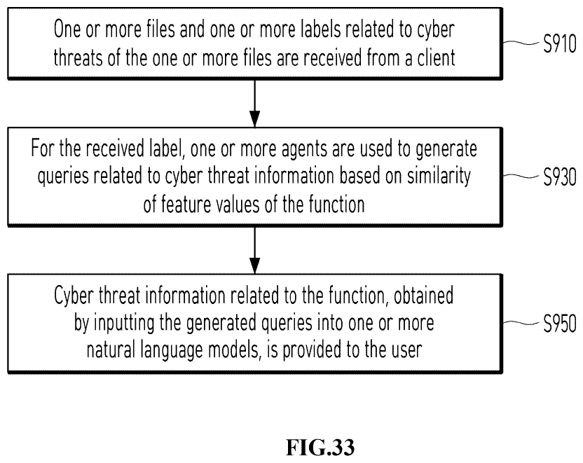

FIG. 33 illustrates another embodiment of a method of processing cyber threat information.

One or more files and one or more labels related to cyber threats of the one or more files are received from a client (S910).

A user may input N files and labels respectively corresponding to the N files into a cyber threat processing device according to an embodiment. As in the embodiments disclosed above, the cyber threat processing device is a computing system including one or more processors and a storage device that perform each data processing step, and may receive various files, information, requests, and the like from the user, for example, in a platform form. An embodiment thereof will be described in detail below.

A label is information related to cyber threats, and one or more labels may correspond to each file, or the label may correspond to a function included in the file. In one example of the cyber threat processing device, a cyber threat related label associated with a single file is received from the user.

When a file is received, the file may be preprocessed according to the examples disclosed above, and functions that may affect cyber threats may be extracted.

Examples of extracting functions that may affect cyber threats from a file are illustrated in detail in FIGS. 20 to 28.

Labels provided by the user may be labeling information exemplified above. For example, when the user has access to the function prompt database disclosed above, the user may obtain related labeling information by referring to it. Otherwise, the user may provide a self-generated label in relation to cyber threats that the user knows or has analyzed. Accordingly, the label herein simply means a value or information having cyber threat relevance that can be used to analyze cyber threat information.

For the received label, one or more agents are used to generate queries related to cyber threat information based on similarity of feature values of the function (S930).

A target function, which is a related function in relation to the received label, may be analyzed and a comparison function similar to the target function may be found.

In this case, the target function may be converted into a feature vector by using an embedding model, and a comparison function that is a similar function may be found based on a custom similarity.

Additionally, with respect to similarity between the target function and the comparison function, one or more prompts may be prepared that generate queries, using an AI agent, for obtaining cyber threat analysis and distinguishing points of the function.

Embodiments related thereto are disclosed in detail in FIGS. 29 to 32.

Cyber threat information related to the function, obtained by inputting the generated queries into one or more natural language models, is provided to the user (S950).

When queries generated using the prepared prompts are input to a natural language model, a cyber threat information report may be generated that includes contents summarizing code analysis of the function, differences in functionality in terms of cyber threats, threat impacts, and various pieces of information regarding cyber threats according to the queries.

Based on the above steps, when the user provides a file and a label, the user can obtain a cyber threat information report consistently and quickly.

An embodiment related thereto is disclosed in detail in FIG. 32.

When a file and a label related to a cyber threat are obtained in this manner, the embodiment may provide basic analysis information on the file provided as a sample and decompiling information on functions obtained from the file.

An embodiment of obtaining basic analysis information on the file and decompiling information on functions obtained from the file is disclosed in detail in FIG. 21.

The embodiment may provide information on function hash values based on a sample file and important function information on a file provided on the basis of labels. An embodiment thereof is disclosed in detail in FIG. 30.

The embodiment may provide natural language analysis results for a target function.

An embodiment thereof is disclosed in detail in FIG. 32. By using this embodiment, a list of similar functions between files can be provided, and analysis information on malicious files can be provided based on various databases disclosed above.

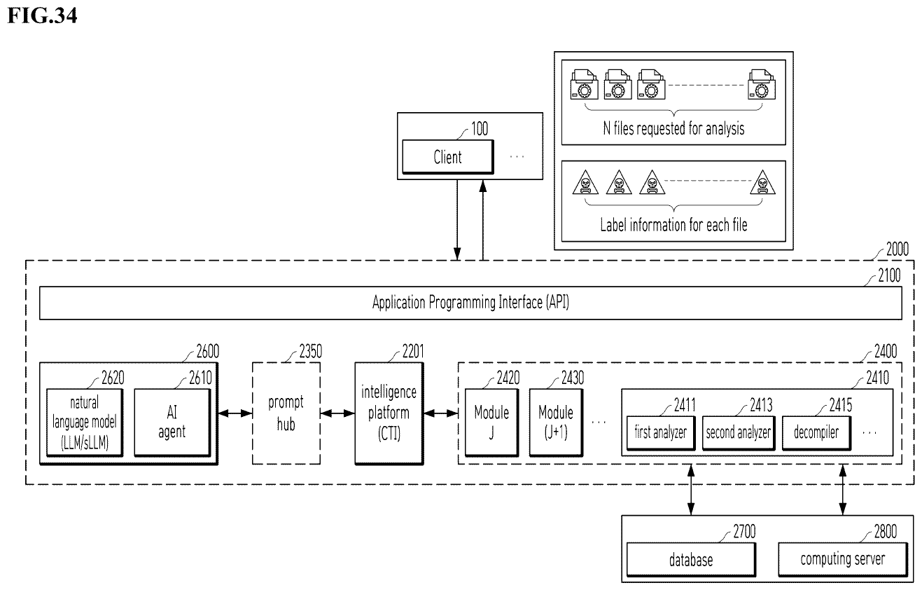

FIG. 34 illustrates another embodiment of a device for processing cyber threat information.

Here, an example is disclosed of a device for processing cyber threat information that, based on the embodiments disclosed above, provides the client device 100 with cyber threat information that is rapid, accurate, and consistent.

In an embodiment of the device for processing cyber threat information, files, labels related to cyber threats, or queries can be received from a user, i.e., the client device 100.

Here, an embodiment is disclosed that has a platform in the form of an Application Programming Interface (API) 2100, but the reception format is not necessarily limited thereto.

In an embodiment, a computing server 2800 including one or more processors that perform the information processing disclosed above and a storage device that stores one or more pieces of data are included. Here, as the storage device, a database (2700) that stores various types of data, as exemplified above, is illustrated.

An intelligence platform (Cyber Threat Intelligence, CTI) 2201 includes, in one or more frameworks, modules that perform various functions, and by using these, can process information, files, queries, and the like provided by the client device 100 and provide processed cyber threat information to the user through the API or another channel.

Various examples in which the intelligence platform (Cyber Threat Intelligence, CTI) 2201 processes information have already been disclosed in FIGS. 1 to 19.

A data processing unit 2400 can extract functions from a file input from the client device 100 and process cyber threat information for a function-unit code set. The data processing unit 2400 may be included in the intelligence platform (Cyber Threat Intelligence, CTI) 2201, or may be a separate system that is not included therein.

A prompt hub 2350 can generate various queries for a natural language model unit 2600 including an AI agent 2610 and a natural language model 2620.

The prompt hub 2350 may be included in the natural language model unit 2600, or may be included in the intelligence platform (Cyber Threat Intelligence, CTI) 2201.

Since the natural language model unit 2600 may use an open-source model or may use its own small natural language model, in this example the prompt hub 2350 is shown as a separate unit.

The data processing unit 2400 includes a decompile module 2410 that decompiles a file, and the decompile module 2410 may include a first analyzer 2411 that analyzes metadata of an input file, a second analyzer 2413 that unpacks the file according to a type of packing, and a decompiler 2415 that decompiles the input file based on decompile structure information.

A detailed embodiment including the decompile module 2410 is disclosed in detail in FIG. 21.

Module J 2420 of the data processing unit 2400 can perform preprocessing into a function-unit code set decompiled by the decompile module 2410.

Module (J+1) 2430 of the data processing unit 2400 can generate query prompts for adding labeling information indicating a cyber threat level to the function-unit code set. In this case, the queries may be automated so as to be included for various AI agents.

When Module (J+1) 2430 of the data processing unit 2400 makes a query to the natural language model 2620, a function-unit code set including labeling information can be obtained.

Embodiments of Module J 2420 and Module (J+1) 2430 of the data processing unit 2400 are disclosed in detail in FIGS. 24 to 28.

If a label has been added to a file provided by the client device 100, the steps of obtaining labeling information in FIGS. 24 to 28 may be omitted.

Module (J+2) 2440 of the data processing unit 2400 converts a function-unit code set extracted from the file into a feature vector by using an embedding model, and Module (J+3) 2450 can convert the feature vector into a hash value of a target function.

And Module (J+4) 2460 can find a similar comparison function of the converted target function hash value, or a hash value of a comparison function, on the basis of various similarity analysis techniques.

At this time, the prompt hub 2350 or a query generation module 2611 in the natural language model unit 2600 can generate queries for performing, by using one or more AI agents, analyses of the target function and the comparison function from a cyber threat perspective.

The natural language model 2620 can generate a cyber threat information report for the file or the label provided by the client device 100 in accordance with the generated queries.

In the case of using an open-source or outside natural language model, in an embodiment, a cyber threat information report generated by the natural language model may be received and then provided to the client device 100.

In the case of using an internal natural language model 2620, a cyber threat information report generated by the natural language model 2620 may be provided to the client device 100.

A detailed example thereof is disclosed in detail in FIG. 32.

A cyber threat information device according to the disclosed embodiments can collect executable files and build a database by attaching labeling information on a cyber threat level to functions included in the executable files.

In this example, only executable files obtained from the client device 100 are illustrated, but a cyber threat device may build a database on cyber threat information by attaching labeling information on a cyber threat level for internal functions, by using executable files collected through various networks connected to network devices or the computing server 2800.

An example of decompiling the collected executable files and extracting a function-unit code set therefrom has been disclosed above.

The process of attaching labeling information to the function-unit code set included in the executable file may also be automatically performed by generating a set of query prompts by using AI agents.

A detailed examples thereof have also been disclosed above.

In this manner, information on cyber threat levels can be collected by attaching labeling information to function-unit code sets included in various executable files, and a database can be built.

That is, for the function-unit code set obtained by the decompile module 2410, a query generation module 2611 generates one or more prompts by using one or more AI agents within the AI agent 2610 according to malicious behavior labeling information.

As a result of the query generation module 2611 making queries to the natural language model 2620 using the generated prompts, a code set in which the labeling information is identified can be stored in the database 2700.

When information on a cyber threat level according to labeling information has been collected in the database, cyber threat analysis for an executable file requested by the client can be enhanced on the basis of the labeling information in the collected function-unit code set.

Above, the examples have been disclosed in which cyber threats can be analyzed by comparing functions of an executable file provided by the client with functions already collected in the database by using AI agents.

The decompile module 2410 extracts a target function from an executable file newly input by the client and converts target-function-based features extracted by the data processing unit 2400.

The query generation module 2611 can generate one or more query prompts, by using one or more AI agents within the AI agent 2610, regarding similarity between a target-function-based feature and a feature of a function previously stored in the database 2700.

And the query generation module 2611 can obtain a report on cyber threat information regarding the function-unit feature, on the basis of results of querying the natural language model 2620 about analysis information, such as differences in terms of cyber threats between the two functions.

In the embodiment, various examples have been disclosed in which cyber threat analysis, which previously had been performed as individual work by experts, can be generated in a consistent and rapid manner by utilizing a natural language model.

According to the disclosed embodiments, time and effort for manually analyzing and generating cyber threat information can be reduced, and reports on analysis of a large number of files can be automatically generated.

According to the disclosed embodiments, embedding retraining is not required, and when generating function-unit hash values for new data, automated data processing is possible without separate model training.

What is claimed is:

1. A method of processing cyber threat information, the method comprising:
converting a target function included in a file to a first hash value;
searching for a comparison function having a similar hash value with the first hash value of the target function based on one or more similarity analyses;
generating one or more prompts using one or more Artificial Intelligence (AI) agents, the prompts including a query regarding similarity between the first hash value and a hash value of the retrieved comparison function; and
submitting the one or more prompts to one or more natural language models and obtaining a natural language report of cyber threat information of the target function.

2. The method of claim 1, wherein a first AI agent among the one or more AI agents generates a query prompt requesting analysis of code differences between the target function and the comparison function.

3. The method of claim 1, wherein a second AI agent among the one or more AI agents generates a query prompt requesting analysis of a change or difference in functionality between the target function and the comparison function.

4. The method of claim 1, wherein a third AI agent among the one or more AI agents generates a query prompt requesting analysis of an impact of the target function and the comparison function on cyber threats.

5. The method of claim 1, wherein a fourth AI agent among the one or more AI agents generates a query prompt requesting a summary regarding cyber threats of the target function and the comparison function.

6. An apparatus for processing cyber threat information, the apparatus comprising:
a database configured to store data; and
a processor configured to process the data, wherein the processor performs steps comprising:
converting a target function included in a file to a first hash value;
searching for a comparison function having a similar hash value with the first hash value of the target function based on one or more similarity analyses;
generating one or more prompts using one or more Artificial Intelligence (AI) agents, the prompts including a query regarding similarity between the first hash value and a hash value of the retrieved comparison function; and
submitting the one or more prompts to one or more natural language models and obtaining a natural language report of cyber threat information of the target function.

7. The apparatus of claim 6, wherein a first AI agent among the one or more AI agents generates a query prompt requesting analysis of code differences between the target function and the comparison function.

8. The apparatus of claim 6, wherein a second AI agent among the one or more AI agents generates a query prompt requesting analysis of a change or difference in functionality between the target function and the comparison function.

9. The apparatus of claim 6, wherein a third AI agent among the one or more AI agents generates a query prompt requesting analysis of an impact of the target function and the comparison function on cyber threats.

10. The apparatus of claim 6, wherein a fourth AI agent among the one or more AI agents generates a query prompt requesting a summary regarding cyber threats of the target function and the comparison function.

11. A non-transitory storage medium storing a computer-readable program for performing steps comprising:
converting a target function included in a file to a first hash value;
searching for a comparison function having a similar hash value with the first hash value of the target function based on one or more similarity analyses;
generating one or more prompts using one or more Artificial Intelligence (AI) agents, the prompts including a query regarding similarity between the first hash value and a hash value of the retrieved comparison function; and
submitting the one or more prompts to one or more natural language models and obtaining a natural language report of cyber threat information of the target function.

12. The non-transitory storage medium of claim 11, wherein a first AI agent among the one or more AI agents generates a query prompt requesting analysis of code differences between the target function and the comparison function.

13. The non-transitory storage medium of claim 11, wherein a second AI agent among the one or more AI agents generates a query prompt requesting analysis of a change or difference in functionality between the target function and the comparison function.

14. The non-transitory storage medium of claim 11, wherein a third AI agent among the one or more AI agents generates a query prompt requesting analysis of an impact of the target function and the comparison function on cyber threats.

15. The non-transitory storage medium of claim 11, wherein a fourth AI agent among the one or more AI agents generates a query prompt requesting a summary regarding cyber threats of the target function and the comparison function.
